(19) United States
(12) Patent Application Publication
(10) Pub. No.: US 2010/0265201 A1
(43) Pub. Date: Oct. 21, 2010

(54) DATA INPUT DEVICE

(76) Inventor: Eui Jin Oh, Daejeon (KR)

Correspondence Address: LEXYOUME IP GROUP, LLC, 5180 PARKSTONE DRIVE, SUITE 175, CHANTILLY, VA, 20151, US

(21) Appl. No.: 12/810,539

(22) PCT Filed: Dec. 31, 2008
(86) PCT No.: PCT/KR08/07901

§ 371 Date: Jun. 25, 2010

(30) Foreign Application Priority Data
Dec. 31, 2007 (KR) 10-2007-0141770

(51) Int. Cl. G06F 3/033; G06F 3/041

(52) U.S. Cl. 345/173; 345/184

(57) ABSTRACT

The present invention relates to a data input device. The data input device includes a base. An input unit is provided to independently perform first directional input in which the input unit is laterally moved to any one of first direction indication locations, second directional input in which the input unit is tilted downwards and moved to a direction of any one of second direction indications, and third directional input in which any one of third direction indication locations is selected. First detection units detect lateral movement of the input unit. Second detection units detect tilting movement of the input unit. Third detection units detect the third directional input; A control unit extracts and inputs a first character, second character and third character assigned to each first direction indication location, each second direction indication location, and each third direction indication location, respectively.

### TECHNICAL FIELD

The present invention relates, in general, to a data input device, and, more particularly, to a data input device that is capable of simultaneously or sequentially performing three types of input actions for respective direction indication locations using one input unit, thus enabling one or more phonemes to be rapidly and accurately input through one action while maximizing the number of characters that can be input through one action in a minimum of input space.

### BACKGROUND ART

With the development of software and semiconductor technology and data processing technology, information devices are gradually becoming smaller, so that the importance of inputting characters using such information devices is gradually increasing. Meanwhile, the input of various characters or instructions to such information devices exhibits many problems.

For example, input devices, such as keyboards, used in Personal Computers (PCs) or notebook computers, cause difficulty when realizing small-sized information devices because there is a limitation on the reduction in the size thereof. Further, touch screen schemes used in Personal Data Assistants (PDAs) and keypad schemes used in mobile phones are inconvenient because the speed of input is slow and the incidence of erroneous input is high.

In order to input characters, numbers or symbols to the above-described information devices, such as PCs, notebook computers, PDAs or mobile phones, at a higher speed, it is necessary to perform a so-called one action-one phoneme input, in which one phoneme (character) is input through one input action. When such one action-one phoneme input is applied to the Korean alphabet, it is necessary to provide buttons or input keys for inputting 24 or more characters on an information device.

When the target language of input is English, Japanese or some other language, a larger number of buttons or input keys is required than in the case of the Korean alphabet. Further, as the performance of a desk-top PC has been implemented in portable terminals, this implementation results in a situation in which, in addition to a character input function, all of the input functions of a keyboard such as the input of various types of command keys (Enter, Space, Shift, etc.) and symbols must be able to be performed using the portable terminal.

However, conventional input devices used in various types of information devices adopt a scheme of assigning characters to respective input keys and inputting the characters by striking or pressing the input keys using the fingers. Due thereto, it is difficult to arrange 24 or more finger-sized input keys on a personal mobile information terminal having a small area for the arrangement of input keys, such as a mobile phone. This is the reason why it has been difficult to realize small-sized keyboards to date.

In particular, in the case of mobile phones, since 24 or more Korean alphabet letters are input using only 12 buttons, it is inevitable that a plurality of letters is arranged on each button.

Accordingly, a repeated input phenomenon, in which an input action is repeated twice or three times to input one letter (phoneme), occurs frequently, so that input time increases in proportion to the number of repetitions and erroneous input occurs frequently.

Further, since such an input method itself is greatly complicated, there is a problem in that it takes a long time to become accustomed to the input method.

In order to overcome the above problem, in the case of the input of the Korean alphabet, a character input method of inputting characters through combination, known as Cheonjiin, has been proposed.

This method is advantageous in that, since a desired character is generated by combining fundamental letters with each other, the number of input buttons to which characters are assigned can be reduced, but is disadvantageous in that, since an input button must be repeatedly pressed until desired letters are combined, input time increases in proportion to the number of repetitions.

Furthermore, technologies, including a roll-up keyboard, which can be rolled up and then carried, and a virtual laser keyboard, which is configured to project an image of a keyboard onto a surface, detect the locations of the fingers when actions similar to keyboard input actions are performed on the image using the fingers, and perform input, have been proposed. However, such types of input devices have problems in that they are inconvenient because they must always be carried, and in that the types of input devices are not suitable for application to personal portable information terminals requiring input in the state in which the personal portable information terminals are held in the hands while moving because input can be performed only in the state in which those types of input devices are placed on supporting surfaces.

### DISCLOSURE OF INVENTION

### Technical Problem

Accordingly, an object of the present invention is to provide a data input device, which simultaneously or sequentially performs three types of input actions, that is, first directional input, second directional input and third directional input using one input unit, thus enabling each desired character to be rapidly and accurately input through one input action while minimizing the area required for the input of characters or the like.

Another object of the present invention is to provide a data input device, which uses first directional input, second directional input and third directional input independently or in combination, thus enabling the data input device to be utilized in various fields such as three-dimensional graphic operations or three-dimensional map operations.

### Technical Solution

In order to accomplish the above objects, the present invention provides a data input device, comprising a base; an input unit provided on the base, wherein the input unit is provided to enable first directional input in which the input unit is laterally moved from a reference location to any one of a plurality of first direction indication locations arranged radially around the reference location and spaced apart from one another within a predetermined input radius, second directional input in which the entire input unit is tilted downwards and moved from a horizontal position to a direction of any one of a plurality of second direction indication locations arranged radially around the reference location and spaced apart from one another, and third directional input in which any one of a plurality of third direction indication locations arranged radially on the input unit itself and spaced apart from one another is selected, to be independently performed; first detection units for detecting lateral movement of the input unit; second detection units for detecting tilting movement of the input unit; third detection units for detecting the third directional input; and a control unit for extracting a first character assigned to each first direction indication location, a second character assigned to each second direction indication location, and a third character assigned to each third direction indication location from a memory unit and inputting the extracted characters on a basis of results of detection of the first, second and third detection units.

The third directional input may be performed in such a way that the input unit is tilted downwards to a direction of any one of the third direction indication locations.

The third directional input may be performed in such a way that any one of press parts provided on the input unit to correspond to the respective third direction indication locations is selected.

The input unit may be configured to enable central input to be performed using one or more of a method in which a central input key provided at a center of the input unit is selected and a method in which the entire input unit is moved vertically to the base.

The central input may be provided to be performed in two or more steps, that is, in multiple steps.

When combined central input performed through combination with any one of the central input, the first directional input, the second directional input and the third directional input is performed, characters different from characters originally assigned to the first direction indication locations, the second direction indication locations and the third direction indication locations are input.

One or more of the first directional input, the second directional input and the third directional input may be provided to be performed in two or more steps, that is, in multiple steps, depending on distance of lateral movement of the input unit, a degree of tilting movement, an angle of tilting, a distance of pressing of the press parts, or intensity of pressing pressure.

Vowels may be assigned to one of the first direction indication locations, the second direction indication locations and the third direction indication locations, and consonants may be assigned to remaining direction indication locations.

The input unit may be provided such that two or more input units are provided on the base.

The data input device may further comprise a first elastic part provided between a bottom of the input unit and the base and configured to support the input unit so that the input unit is laterally moved along a top surface of the first elastic part, and to return the input unit to an initial position at a time of performing tilting movement of the input unit, and a second elastic part provided between a circumferential portion of the input unit and the base and configured to return the input unit to the initial position at a time of performing lateral movement of the input unit.

The first detection units corresponding to the respective first direction indication locations may be provided on an inner circumferential portion of the base, the data input device further comprising first protrusions provided on a circumferential portion of the second elastic part to protrude to correspond to the first detection units and configured to be pressed by the input unit and to come into contact with the first detection units at a time of performing lateral movement of the input unit are.

The base may be configured such that the second detection units corresponding to the respective second direction indication locations, the third detection units corresponding to the respective third direction indication locations and a central input detection unit corresponding to a bottom of the central input key are arranged in the base, the data input device further comprising second protrusions provided on a circumferential portion of the first elastic part to protrude to correspond to the respective second detection units and configured to be pressed by the input unit and to come into contact with the second detection units at a time of performing tilting movement of the input unit, third protrusions protruded to correspond to the respective third detection units and configured to be pressed by the input unit and to come into contact with the third detection units at a time of performing tilting of the input unit, and a central protrusion protruded from the first elastic part to correspond to a bottom of the central input key and configured to come into contact with the central input detection unit at a time of performing central input, the third protrusions and the central protrusion being provided on a bottom of the first elastic part.

The data input device may further comprise a hemispheric support unit provided between the bottom of the input unit and the base and curved toward the input unit; and wherein the input unit comprises a first input unit, a bottom contact surface of which corresponds to a top surface of the support unit and which is tilted downwards and moved along the support unit, and a second input unit placed on a top surface of the first input unit and provided to be laterally movable along the top surface of the first input unit.

The data input device may further comprise third protrusions protruded to correspond to the third direction indication locations and configured to move and come into contact with the third detection units at a time of performing the third directional input, and a central protrusion protruded toward the base to correspond to a center of the input unit and configured to come into contact with the central input detection unit at a time of performing the central input, the third protrusions and the central protrusion being provided on a bottom of the support unit facing the base.

The first detection units may be arranged on the inner circumferential portion of the base to correspond to the respective first direction indication locations so that the second input unit comes into contact with the first detection units at a time of performing lateral movement of the second input unit; and the second detection units are arranged on the bottom surface of the base to correspond to the respective second direction indication locations so that the first input unit comes into contact with the second detection units at a time of performing tilting movement of the first input unit.

The data input device may further comprise an input switching unit disposed between the first input unit and the second input unit and configured to enable tilting movement of the first input unit or lateral movement of the second input unit to be selectively performed.

The data input device may further comprise a movable support unit provided between the bottom of the input unit and the base and configured to have a hemispheric shape, curved toward the input unit and to be laterally moved together with the input unit at a time of performing the first directional input, third protrusions protruding toward the third detection units arranged on the base, and a central protrusion protruding toward the central input detection unit, the third protrusions and the central protrusion being formed on a bottom of the movable support unit; and wherein the input unit has a bottom contact surface corresponding to a shape of a top surface of the movable support unit, and performs the second directional input in such a way that the input unit is tilted downwards and moved along with the movable support unit.

The data input device may further comprise second protrusions protruding toward the second detection units to correspond to the respective second direction indication locations along a circumferential portion of the input unit.

The data input device may further comprise a return element provided between the movable support unit and the base and configured to return both the input unit and the movable support unit to the reference location at a time of performing the first directional input.

When a three-dimensional graphic operation is performed using the input unit, movement of a subject is performed through the first directional input, enlargement or reduction of the subject are performed through third directional input in left/right directions, clockwise or counterclockwise planar rotation of the subject is performed through the third directional input in forward/backward directions, and three-dimensional rotation of the subject is performed through the second directional input.

The data input device may further comprise a plurality of touch detection units provided along a peripheral portion of a top of the input unit and configured to perform the planar rotation according to a direction of continuous touching of the touch detection units.

The input unit may be provided to be rotatable in left and right directions by using a normal line of a plane of the base passing through the reference location as a shaft, and performs planar rotation of the subject by rotation of the input unit.

When a three-dimensional map search operation is performed using the input unit, movement of a mouse pointer is performed through the first directional input, an operation of left/right buttons of the mouse is performed through the third directional input in left/right directions, enlargement or reduction of the map is performed through the third directional input in forward/backward directions, and three-dimensional tilting of the map is performed through the second directional input; and when the first directional input is performed in a state in which the central input has been performed, movement of the map is performed.

The data input device may further comprise a plurality of touch detection units provided along a peripheral portion of a top of the input unit and configured to perform clockwise or counterclockwise planar rotation of the map according to a direction of continuous touching of the touch detection units.

The input unit is provided to be rotatable in left and right directions by using a normal line of a plane of the base passing through the reference location as a shaft, and performs clockwise or counterclockwise planar rotation of the map by rotation of the input unit.

When a mouse mode is input, movement of a mouse pointer is performed through the first directional input, any one of window view, window enlargement/reduction and window open/close functions is performed through the second directional input in a direction of 12 and 6 o'clock, a window turn function to each direction is performed through the second directional input in a direction of 3 and 9 o'clock, a scroll up/down function is performed through the third directional input in a direction of 12 and 6 o'clock, a scroll wheel function is performed through the third directional input in a direction of 9 o'clock, and a mouse right button function is performed through the third directional input in a direction of 3 o'clock.

The first, second and third detection units may be implemented using a touch pad or a touch screen arranged in an input area.

The data input device may further comprise a connection element for enabling the input unit to be put on the base provided in the input area, thus enabling the respective directional inputs to be performed.

The connection element may comprise a band-shaped main body, a reception part provided in the main body and configured to receive the input unit to enable the respective directional inputs to be performed, and movable support parts provided at both ends of the main body and slidably coupled to the base.

The connection element may comprise a main body, a reception part provided in the main body and configured to receive the input unit to enable the respective directional inputs to be performed, and a hinge part configured to allow the input unit to be put on the input radius in such a way that the main body rotates with respect to the base.

Combinations of the central input with the respective directional inputs may be discriminated from each other according to a sequence of the combinations, thereby generating different input signals.

Combined directional input, in which two or more of the first directional input, the second directional input and the third directional input are combined with each other to generate new input signals, may be provided to be performed.

The combined directional input may be configured to generate different input signals according to a sequence of combination of the respective directional inputs.

New input signals may be generated through combined central input in which, after any one of the first directional input, the second directional input and the third directional input is primarily performed, the central input is performed, and then any one of the respective directional inputs is subsequently performed.

A display unit provided on the base may comprise a character display unit on which characters to be input through the respective directional inputs or the central input are indicated, and the character display unit is configured such that, when the directional inputs or the central input are sequentially performed, characters that can be input at respective input locations or anticipated words thereof are indicated, thus enabling a relevant character or a relevant anticipated word thereof to be input at a time when a relevant input action is performed.

Further, in order to accomplish the above objects, the present invention provides a data input device, comprising a base; an input unit provided on the base, wherein the input unit is provided to enable first directional input in which the input unit is laterally moved from a reference location to any one of a plurality of first direction indication locations arranged radially around the reference location and spaced apart from one another within a predetermined input radius, third directional input in which the input unit is tilted downwards to a direction of any one of a plurality of third direction indication locations arranged radially on the input unit itself and spaced apart from one another, and central input in which the input unit is moved vertically to the base, to be independently performed; a support unit provided between a bottom of the input unit and the base and configured to support lateral movement and tilting of the input unit, the support unit being configured such that a central protrusion, protruding from a center of the input unit toward the base, and a plurality of third protrusions, protruding from locations corresponding to the respective third direction indication locations toward the base, are provided on a bottom of the support unit; first detection units provided along an inner circumferential portion of the base to correspond to the respective first direction indication locations and configured to detect contact with the input unit at a time of performing the first directional input; third detection units for detecting contact with the third protrusions at a time of performing the third directional input; a central input detection unit for detecting contact with the central protrusion at a time of performing the central input; and a control unit for extracting a first character assigned to each first direction indication location, a third character assigned to each third direction indication location or an input command assigned to the central input from a memory unit and inputting the extracted character or command on a basis of results of detection of the first detection units, the third detection units and the central input detection unit.

The data input device may further comprise first protrusions protruding toward the respective first detection units along a circumferential portion of the input unit; and a return element provided between the input unit and the base and configured to return the input unit to the reference location at a time of performing the first directional input.

Further, in order to accomplish the above objects, the present invention provides a data input device, comprising a base; an input unit provided on the base, wherein the input unit is provided to enable first directional input in which the input unit is laterally moved from a reference location to any one of a plurality of first direction indication locations arranged radially around the reference location and spaced apart from one another within a predetermined input radius, and third directional input in which the input unit is tilted downwards to a direction of any one of a plurality of third direction indication locations arranged radially on the input unit itself and spaced apart from one another, to be independently performed; a support unit provided between a bottom of the input unit and the base and configured to support lateral movement and tilting of the input unit; a rod having one end extended to a bottom of the input unit; a first detection unit provided at a remaining end of the rod and configured to detect movement direction of the rod attributable to the lateral movement of the input unit; third detection units provided on a bottom of the support unit to correspond to the respective third direction indication locations and configured to come into contact with the support unit at a time of performing the third directional input; and a control unit configured to extract a first character assigned to each first direction indication location or a third character assigned to each third direction indication location from a memory unit and input the extracted character on a basis of results of detection of the first detection unit and the third detection unit.

Further, in order to accomplish the above objects, the present invention provides a data input device, comprising a base; an input unit provided on the base, wherein the input unit comprises an inward input unit for performing second directional input in which the inward input unit is tilted from a horizontal position downwards to a direction of any one of a plurality of second direction indication locations arranged radially around a reference location and spaced apart from one another, and an outward input unit provided along a peripheral portion of the inward input unit outside the inward input unit and configured to perform third directional input in which any one of a plurality of third direction indication locations arranged radially around the reference location and spaced apart from one another is selected, wherein the input unit is provided to enable first directional input, in which the inward and outward input units are simultaneously laterally moved from the reference location to any one of a plurality of first direction indication locations arranged radially around the reference location and spaced apart from one another, to be performed; a first detection unit for detecting the first directional input; a second detection unit for detecting the second directional input; a third detection unit for detecting the third directional input; and a control unit for extracting a first character assigned to each first direction indication location, a second character assigned to each second direction indication location, and a third character assigned to each third direction indication location from a memory unit and inputting the extracted characters on a basis of results of detection of the first, second and third detection units.

Further, in order to accomplish the above objects, the present invention provides a data input device, comprising a base; an input unit provided on the base, wherein the input unit comprises an inward input unit for performing second directional input in which any one of a plurality of third direction indication locations arranged radially around a reference location and spaced apart from one another is selected from a horizontal position, and an outward input unit provided along a peripheral portion of the inward input unit outside the inward input unit and configured to perform second directional input in which the outward input unit is tilted downwards to a direction of any one of a plurality of second direction indication locations arranged radially around the reference location and spaced apart from one another, wherein the input unit is provided to enable first directional input, in which the inward and outward input units are simultaneously laterally moved from the reference location to any one of a plurality of first direction indication locations arranged radially around the reference location and spaced apart from one another, to be performed; a first detection unit for detecting the first directional input; a second detection unit for detecting the second directional input; a third detection unit for detecting the third directional input; and a control unit for extracting a first character assigned to each first direction indication location, a second character assigned to each second direction indication location, and a third character assigned to each third direction indication location from a memory unit and inputting the extracted characters on a basis of results of detection of the first, second and third detection units.

Further, in order to accomplish the above objects, the present invention provides a data input device, comprising a base; an input unit provided on the base, wherein the input unit comprises an inward input unit for performing second directional input in which the inward input unit is tilted from a horizontal position downwards to a direction of any one of a plurality of second direction indication locations arranged radially around a reference location and spaced apart from one another, and an outward input unit provided along a peripheral portion of the inward input unit outside the inward input unit and configured to perform third directional input in which any one of a plurality of third direction indication locations arranged radially around the reference location and spaced apart from one another is selected, wherein the input unit is provided to enable first directional input, in which the inward and outward input units are simultaneously laterally moved from the reference location to any one of a plurality of first direction indication locations arranged radially around the reference location and spaced apart from one another, to be performed; a first detection unit for detecting the first directional input; a second detection unit for detecting the second directional input; a third detection unit for detecting the third directional input; and a control unit for extracting a first character assigned to each first direction indication location, a second character assigned to each second direction indication location, and a third character assigned to each third direction indication location from a memory unit and inputting the extracted characters on a basis of results of detection of the first, second and third detection units.

The outward input unit may be provided to be divided into portions corresponding to the respective direction indication locations.

The outward input unit may be provided in a shape of an integrated ring enclosing an outer portion of the inward input unit.

The outward input unit may be configured such that a section of an upper portion thereof is formed to be upwardly inclined in a direction from an inward edge portion to an outward edge portion.

The outward input unit may be provided as a plurality of outward input units along the peripheral portion of a top of the inward input unit, and an elastic element for returning the outward input unit to an original position thereof after the third directional input has been performed is further provided between the outward input units and the inward input unit.

Further, in order to accomplish the above objects, the present invention provides a data input device, comprising a base; a movable support unit provided on the base; an input unit placed on the movable support unit, wherein the input unit performs first directional input in such a way that both the input unit and the movable support unit are laterally moved from a reference location to each radial direction, second directional input in such a way that the input unit is tilted downwards in each radial direction on a top of the movable support unit, and third directional input in such a way that a peripheral portion of the top of the input unit corresponding to each radial direction is pressed; a first detection unit for detecting lateral movement of the input unit; a second detection unit for detecting tilting movement of the input unit; a third detection unit for detecting the third directional input; and a control unit for extracting a first character assigned to each first direction indication location, a second character assigned to each second direction indication location, and a third character assigned to each third direction indication location from a memory unit and inputting the extracted characters on a basis of results of detection of the first, second and third detection units.

The input unit may comprise a first input unit and a second input unit placed on a top of the first input unit and configured to perform the third directional input, and a tilting stop projection for preventing tilting of the first input unit at a time of performing the third directional input is further provided on a circumferential portion of the first input unit.

The data input device may further comprise an elastic element provided between the first input unit and the movable support unit and configured to perform the second directional input while the elastic element is elastically deformed at a time of tilting the first input unit, and to return the first input unit to an original position after the second directional input has been performed.

Further, in order to accomplish the above objects, the present invention provides a data input device, comprising a base; a movable support unit provided on the base; an input unit placed on the movable support unit, wherein the input unit performs first directional input in such a way that both the input unit and the movable support unit are laterally moved from a reference location to each radial direction, performs second directional input in such a way that a peripheral portion of a top of the input unit corresponding to each radial direction is tilted downwards, and performs third directional input in such a way that the peripheral portion of the top of the input unit corresponding to each radial direction is pressed; a first detection unit for detecting lateral movement of the input unit; a second detection unit for detecting tilting movement of the input unit; a third detection unit for detecting the third directional input; and a control unit for extracting a first character assigned to each first direction indication location, a second character assigned to each second direction indication location, and a third character assigned to each third direction indication location from a memory unit and inputting the extracted characters on a basis of results of detection of the first, second and third detection units.

Further, the data input device may further comprise elastic projections protruding from a top of the support unit to correspond to the respective second direction indication locations and third direction indication locations, and semicircular support units provided between the elastic projections and the input unit, and wherein, at a time of performing the second directional input, the semicircular support units are rotated in a direction of tilting of the input unit and come into contact with the second detection unit, and at a time of performing the third directional input, the semicircular support units are moved downwards and come into contact with the third detection unit.

The data input device may further comprise an elastic element disposed between the movable support unit and the base and elastically deformed in a direction of tilting of the input unit at a time of performing the second directional input.

The data input device may further comprise an input switching unit disposed between the input unit and the movable support unit and configured to prevent the input unit from being tilted downwards at a time of performing the third directional input.

Further, in order to accomplish the above objects, the present invention provides a data input device, comprising a base; an input unit provided on the base in a disk shape and provided with a rod-shaped support projection which is formed on a bottom of the input unit and protrudes toward the base, wherein the input unit is provided to enable first directional input in which the input unit is laterally moved from a reference location to each of first direction indication locations, second directional input in which the input unit is tilted downwards to a direction of each of second direction indication locations, and third directional input in which each of third direction indication locations on a top of the input unit is pressed, to be independently performed; a support unit provided between the base and the input unit and provided with a reception hole which is formed at a center of the support unit to receive the support projection to enable tilting; a first detection unit for detecting lateral movement of the input unit; a second detection unit for detecting tilting movement of the input unit; a third detection unit for detecting the third directional input; and a control unit for extracting a first character assigned to each first direction indication location, a second character assigned to each second direction indication location, and a third character assigned to each third direction indication location from a memory unit and inputting the extracted characters on a basis of results of detection of the first, second and third detection units.

Further, in order to accomplish the above objects, the present invention provides a data input device, comprising a base; an input unit provided on the base, wherein the input unit is provided to enable first directional input in which the input unit is laterally moved from a reference location to each first direction indication location, second directional input in which a press location provided at each of second direction indication locations arranged along a peripheral portion of the input unit is selected, and third directional input in which a press location provided at each of third direction indication locations arranged along the peripheral portion of the input unit in alternation with the second direction indication locations is selected, to be independently performed; a first detection unit for detecting the first directional input; a second detection unit for detecting the second directional input; a third detection unit for detecting the third directional input; and a control unit for extracting a first character assigned to each first direction indication location, a second character assigned to each second direction indication location, and a third character assigned to each third direction indication location from a memory unit and inputting the extracted characters on a basis of results of detection of the first, second and third detection units.

The input unit may comprise an inward input unit in which respective press locations protrude to correspond to the second direction indication locations, and a plurality of outward input units provided to correspond to the respective third direction indication locations.

Further, in order to accomplish the above objects, the present invention provides a data input device, comprising a base; an input unit provided on the base, wherein the input unit is provided to enable first directional input in which the input unit is laterally moved from a reference location to each of first direction indication locations, second directional input in which the input unit is tilted downwards to a direction of each of second direction indication locations, and third directional input in which the input unit is tilted downwards to a direction of each of third direction indication locations arranged in alternation with the second direction indication locations, to be independently performed; a first detection unit for detecting the first directional input; a second detection unit for detecting the second directional input; a third detection unit for detecting the third directional input; and a control unit for extracting a first character assigned to each first direction indication location, a second character assigned to each second direction indication location, and a third character assigned to each third direction indication location from a memory unit and inputting the extracted characters on a basis of results of detection of the first, second and third detection units.

Further, the input unit may comprise an inward input unit, a plurality of outward input units provided to correspond to the respective third direction indication locations along a circumferential portion of the inward input unit, and elastic elements provided between the inward input unit and the respective outward input units.

Further, in order to accomplish the above objects, the present invention provides a data input device, comprising a base; a first input unit provided on the base and configured to perform first directional input in which the first input unit is laterally moved from a reference location to each of first direction indication locations; a second input unit formed in a shape of a star having projections extending radially from a center thereof, and provided on the first input unit, the second input unit being provided to enable second directional input in which the second input unit is tilted downwards to a direction of each of second direction indication locations corresponding to the respective projections and third directional input in which the second input unit is pressed at each of third direction indication locations corresponding to the projections, to be independently performed; a first detection unit for detecting the first directional input; a second detection unit for detecting the second directional input; a third detection unit for detecting the third directional input; and a control unit for extracting a first character assigned to each first direction indication location, a second character assigned to each second direction indication location, and a third character assigned to each third direction indication location from a memory unit and inputting the extracted characters on a basis of results of detection of the first, second and third detection units.

The outward input unit may have six projections, four of which are formed to extend in east, west, south and north directions, and two of which are formed to extend in northeast and northwest directions.

Further, in order to accomplish the above objects, the present invention provides a data input device, comprising a base; an input unit provided on the base, wherein the input unit is made of a gel-type elastically deformable material and is provided to enable first directional input in which an entire or partial portion of the input unit is laterally moved from a reference location to each of first direction indication locations, second directional input in which local deformation occurs along a peripheral portion of a top of the input unit due to pressing of each of second direction indication locations, and third directional input in which the top of the input unit is tilted downwards to a direction of each of third direction indication locations along the peripheral portion of the input unit, to be independently performed; a first detection unit for detecting the first directional input; a second detection unit for detecting the second directional input; a third detection unit for detecting the third directional input; and a control unit for extracting a first character assigned to each first direction indication location, a second character assigned to each second direction indication location, and a third character assigned to each third direction indication location from a memory unit and inputting the extracted characters on a basis of results of detection of the first, second and third detection units.

### ADVANTAGEOUS EFFECTS

According to the data input device of the present invention, three types of input actions, that is, first directional input, second directional input and third directional input, can be independently performed using one input unit, thus enabling data such as each desired character to be rapidly and accurately input through one input action in a minimum of input space.

Further, the present invention uses first directional input, second directional input and third directional input independently or in combination, thus enabling the data input device to be utilized in various fields such as three-dimensional graphic operations or three-dimensional map operations.

### BRIEF DESCRIPTION OF DRAWINGS

FIGS. 1 and 2 are conceptual diagrams showing first directional input, second directional input and third directional input in a data input device according to the present invention;

FIG. 3 is a sectional view of a data input device according to a first embodiment of the present invention;

FIG. 4 is a sectional view of a data input device according to a second embodiment of the present invention;

FIG. 5 is a sectional view of a data input device according to a third embodiment of the present invention;

FIG. 6 is a sectional view of a data input device according to a fourth embodiment of the present invention;

FIGS. 7 and 8 are sectional views of a data input device according to other embodiments of the present invention;

FIG. 9 is a sectional view of a data input device according to a fifth embodiment of the present invention;

FIG. 10 is a sectional view showing detailed embodiments of an input unit and a movable support unit according to the present invention;

FIG. 11 is a sectional view of an outward input unit according to the present invention;

FIG. 12 is a diagram showing a tilting stop protrusion according to the present invention;

FIGS. 13 to 17 are sectional views showing various modifications of a data input device according to the present invention;

FIG. 18 is a sectional view of a data input device according to a second embodiment of the present invention;

FIG. 19 is a sectional view of a data input device according to a third embodiment of the present invention;

FIG. 20 is a sectional perspective view showing the input action of the input unit in the data input device according to the third embodiment of the present invention;

FIG. 21 is a sectional perspective view showing a modification of the data input device according to the third embodiment of the present invention;

FIG. 22 is a diagram showing the input action of the input unit according to the third embodiment of the present invention;

FIGS. 23 and 24 are enlarged perspective views of the input unit of the data input device according to the present invention;

FIG. 25 is a sectional view of a data input device according to a fourth embodiment of the present invention;

FIG. 26 is a sectional view of a data input device according to a fifth embodiment of the present invention;

FIG. 27 is a sectional view of data input device according to a sixth embodiment of the present invention;

FIG. 28 illustrates a plan view and a perspective view of a data input device operated through movement, pressing and pressing according to yet another embodiment of the present invention;

FIG. 29 is a sectional view of a data input device operated through movement, tilting and tilting according to yet another embodiment of the present invention;

FIGS. 30 to 32 are sectional views showing various modifications of a data input device according to the present invention;

FIG. 33 is a sectional view of a data input device according to a first embodiment of the present invention;

FIGS. 34 and 35 are sectional views showing various embodiments of the input unit according to the present invention;

FIG. 36 is a conceptual view showing respective functions when the data input device of the present invention is used as a mouse;

FIG. 37 is a conceptual view showing examples of respective directional inputs on a touch screen;

FIG. 38 is a table showing pressure values for respective directional inputs in an immovable type;

FIGS. 39 and 40 are sectional views of various modifications of the data input device according to the present invention;

FIGS. 41 to 42 are diagrams showing operations when the data input device of the present invention is used as a controller;

FIGS. 43 and 44 are conceptual views showing the input of derivatives and anticipated words using the data input device according to the present invention; and

FIGS. 45 to 47 are perspective views showing a data input device according to other embodiments of the present invention.

### BEST MODE FOR CARRYING OUT THE INVENTION

Hereinafter, embodiments of the present invention will be described in detail with reference to the attached drawings.

Referring to FIG. 1, a data input device according to the present invention includes a base 110; an input unit 10 provided on the base 110, wherein the input unit 10 is provided to enable first directional input M1 in which the input unit 10 is laterally moved from a reference location S to any one of a plurality of first direction indication locations m1 arranged radially around the reference location S and spaced apart from one another within a predetermined input radius, second directional input M2 in which the entire input unit 10 is tilted downwards and moved from a horizontal position to the direction of any one of a plurality of second direction indication locations m2 arranged radially around the reference location S and spaced apart from one another, and third directional input M3 in which any one of a plurality of third direction indication locations m3 arranged radially on the input unit 10 itself and spaced apart from one another is selected, to be independently performed; a first detection unit 31 for detecting the lateral movement of the input unit 10; a second detection unit 32 for detecting the tilting movement of the input unit 10; a third detection unit 33 for detecting the third directional input M3; and a control unit (not shown) for extracting a first character assigned to each first direction indication location m1, a second character assigned to each second direction indication location m2, and a third character assigned to each third direction indication location m3 from a memory unit and inputting the extracted characters on the basis of the results of the detection by the first detection unit 31, the second detection unit 32 and the third detection unit 33.

Hereinafter, respective components will be described in detail.

The input unit 10 is provided on the base 110 and configured to enable first directional input M1, second directional input M2 and third directional input M3 to be independently performed.

As shown in FIG. 1(a), first directional input M1 is performed in such a way that the input unit 10 is laterally moved from the reference location S to any one of the first direction indication locations m1 arranged radially around the reference location S and spaced apart from one another within a predetermined input radius provided in the base 110.

Here, the term ‘lateral movement’ includes all actions in which the input unit 10 is laterally moved from the reference location S to the respective first direction indication locations m1, as well as movement in a state exactly horizontal to the base 110.

As shown in FIG. 20, first direction indication locations m1 are arranged radially around the reference location S and spaced apart from one another, and are assigned various types of data, such as characters, symbols, numbers and function commands.

The number of first direction indication locations m1 may be varied according to the circumstances, for example, 4, 8 or 12.

Further, the number of first direction indication locations m1 may be identical to or different from the number of second direction indication locations m2 and the number of third direction indication locations m3, which will be described later.

First detection units 31 are provided to detect the lateral movement of the input unit 10.

The first detection units 31 may be provided in various forms, for example, touch sensors provided on the movement path of the input unit 10 and configured to detect contact with the input unit 10 when the input unit 10 is moved, pressure sensors configured to detect pressure corresponding to the pressing contact of the input unit 10, or optical sensors.

Therefore, the control unit determines which first detection unit 31 has detected the movement of the input unit 10, extracts a character, a symbol or a number assigned to a first direction indication location m1 corresponding to the first detection unit 31 from the memory unit and inputs the extracted character, symbol or number.

Meanwhile, the first directional input M1 may also be performed in such a way that the input unit 10 is moved from the reference location S in a circumferential direction. In this case, a valid input signal selection method may be performed by determining either or both of initial and final values to be valid.

Further, the first directional input M1 may be provided to be performed in two or more steps, that is, in multiple steps, according to the distance of lateral movement.

The determination of whether to input in multiple steps may be performed using various methods. For example, when two or more first detection units 31 are arranged on the movement path of the input unit 10, whether to input in multiple steps may be determined according to the number of first detection units 31 which detect the movement of the input unit 10. Further, when the first detection units 31 are implemented as pressure sensors, whether to input in multiple steps may be determined depending on the intensities of pressures at which pressing is made toward the first detection units 31.

Second directional input M2 is performed in such a way that the entire input unit 10 is tilted downwards and moved to the direction of any one of the second direction indication locations m2 arranged radially around the reference location S and spaced apart from one another.

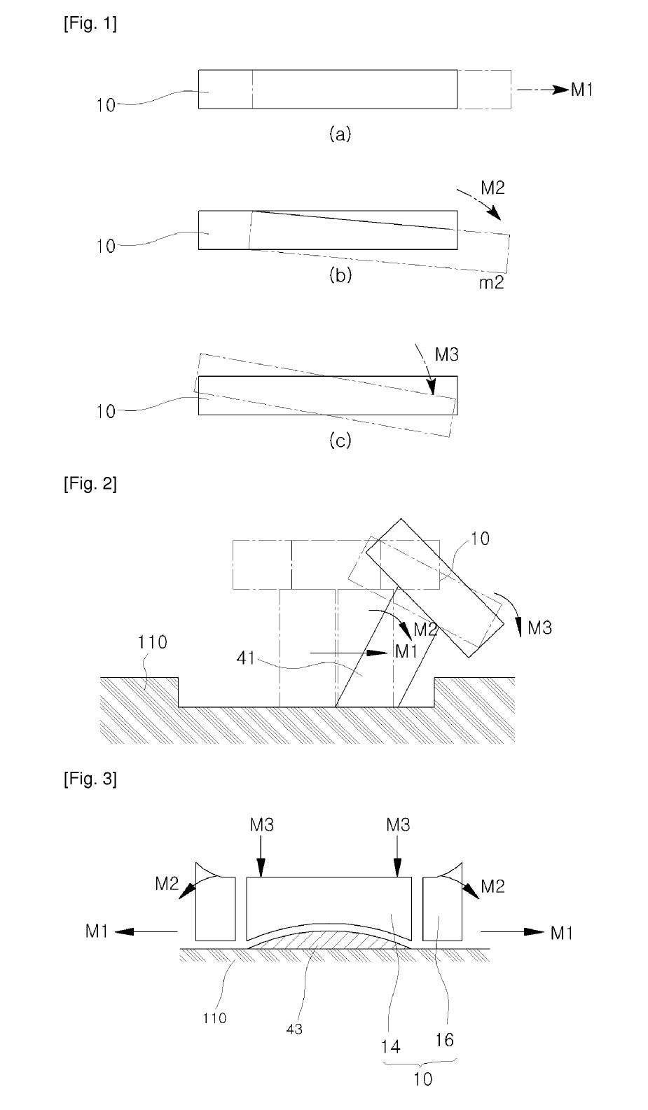

Here, the term ‘tilting movement’ means an action in which, as shown in FIGS. 1(b) and 2, the entire input unit 10 is moved to the direction of a predetermined second direction indication location m2 while being tilted downwards to that direction (accompanied with the movement of the central point of the input unit 10).

Meanwhile, the term ‘tilting’ in the third directional input M3 means an action in which, as shown in FIGS. 1(c) and 2, the input unit 10 is tilted downwards to the direction of a predetermined third direction indication location m3 while keeping its balance.

Methods in which second detection units 32 detect the tilting movement of the input unit 10 may be variously implemented, for example, in such a way as to detect that the circumferential portion of the input unit 10 is moved due to tilting movement and then comes into contact with the second detection units 32, as shown in FIG. 2.

Meanwhile, second directional input M2 may be provided to be performed in two or more steps, that is, in multiple steps, according to the degree of the tilting movement of the input unit 10. For example, in the case of the construction of FIG. 2, steps may be formed on the circumference portion of the input unit 10 so that the input unit 10 sequentially comes into contact with the second detection units 32 according to the degree of the tilting movement of the input unit. Alternatively, multiple steps of input may be discriminated from each other according to the difference between the pressing pressures caused by the tilting movement of the input unit 10.

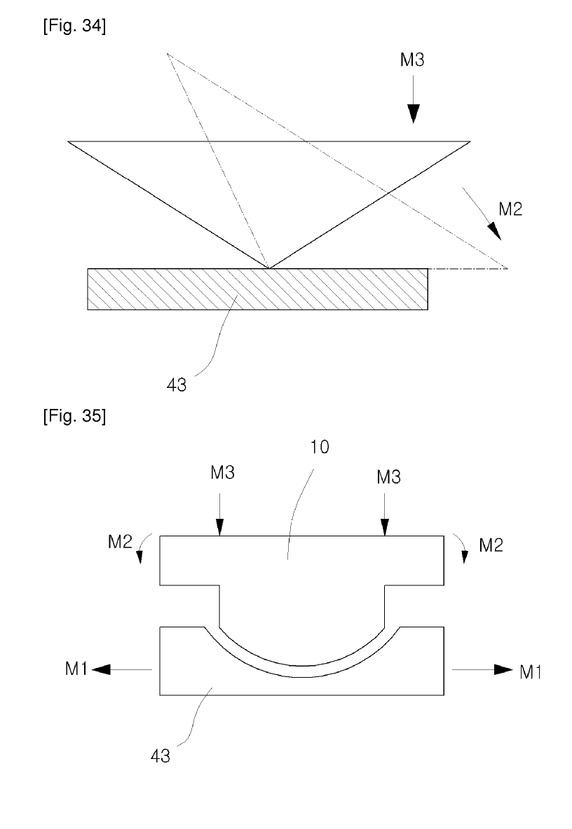

The tilting of the input unit 10 may be performed by, for example, an input unit 10 having an inverted triangular section, as shown in detail in FIG. 34.

In this case, the vertex of the inverted triangle is fixed to a movable support unit 43. Second directional input M2 and third directional input M3 are performed through an action of tilting or pressing the input unit in each radial direction, and first directional input M1 is performed through an action of laterally pushing the input unit.

Further, the input unit 10 has a semicircular shape in which the bottom surface of the input unit is upwardly curved, as shown in FIG. 3, or a semicircular shape in which the bottom surface is downwardly curved in a ‘U’ shape, as shown in FIG. 35.

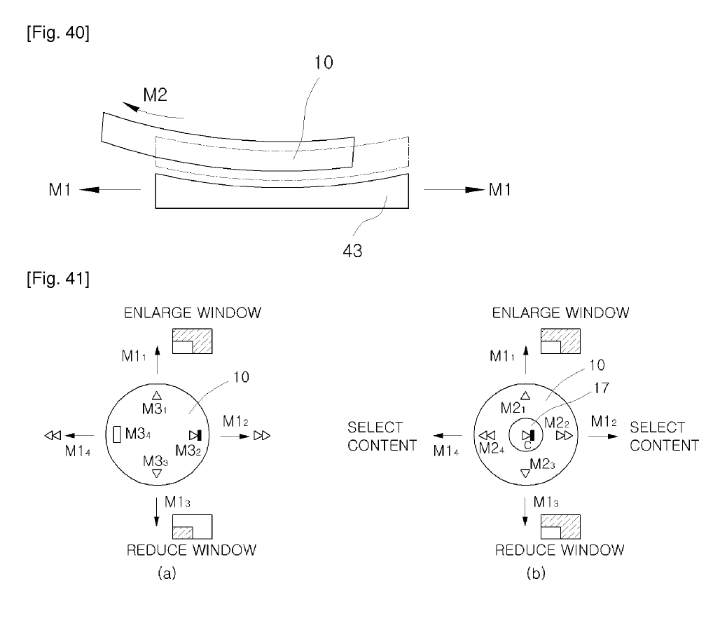

When the bottom surface of the input unit 10 is formed in a ‘U’ shape, surfaces to be tilted are formed in a direction opposite those of other embodiments, and thus the second directional input M2 is performed as shown in FIG. 40.

In this case, when the present invention is used as a wearable input device, tilting movement is performed in such a way as to upwardly push the input unit without downward tilting being performed.

It is apparent that the tilting movement of the input unit 10 can be detected through various detection units capable of performing spatial detection, such as optical sensors and magnetic sensors, as well as touch sensors.

Third directional input M3 is performed in such a way as to select any one of the third direction indication locations m3 arranged radially on the input unit 10 itself and spaced apart from one another.

The third directional input M3 may be provided to be performed in various forms, for example, in such a way that, as shown in FIG. 1(c), the input unit 10 is tilted downwards to the direction of any one of the third direction indication locations m3.

Further, the third directional input M3 may also be performed by selecting any one of a plurality of press parts (not shown, for example, push buttons or the like) provided on the input unit 10 to correspond to the respective third direction indication locations m3.

The press parts may be provided at various locations, for example, on the top of the input unit 10, between the input unit 10 and a support unit 41, or below the support unit 41.

Third detection units 33 may be provided in various forms according to the type of third directional input M3. For example, when third directional input M3 is performed by press parts, the third detection units 33 may be provided at corresponding third direction indication locations m3 of the input unit 10 as push button switches, rubber domes, pressure sensors or touch sensors. Further, when third directional input M3 is performed by the tilting of the input unit 10, the third detection units 33 may be provided in the same form as the above-described second detection units 32.

Here, it is apparent that the third directional input M3 may be provided to be performed in two or more steps, that is, in multiple steps, according to the angle of tilting of the input unit 10, or the pressing distance of press parts 19 or the intensity of pressing pressure.

The control unit extracts a first character assigned to each first direction indication location m1, a second character assigned to each second direction indication location m2, and a third character assigned to each third direction indication location m3 from the memory unit (not shown) and inputs the first, second and third characters on the basis of the results of the detection by the first, second and third detection units 31, 32 and 33.

The above-described first directional input M1, second directional input M2 and third directional input M3 may be independently performed, for example, sequentially or simultaneously.

That is, the data input device according to the present invention may independently perform the above three types of input actions (lateral movement, tilting movement, and pressing or tilting).

Therefore, in the state in which one of lateral movement, tilting movement, and pressing or tilting is performed in the direction of a predetermined direction indication location, another action may be performed in the same or different direction.

For example, pressing or tilting (third directional input M3) may be performed even in the state in which tilting movement (second directional input M2) is not performed, or may be performed for a predetermined direction indication location in the state in which tilting movement is performed for another direction indication location.

Therefore, the data input device of the present invention can input three phonemes such as consonant+vowel+consonant through one input action, and can simultaneously perform the movement, three-dimensional rotation, enlargement, reduction and planar rotation of content at the time of manipulating three-dimensional content.

FIG. 20 is a sectional perspective view of the input unit 10 when first directional input M1, second directional input M2 and third directional input M3 have been performed.

Referring to the drawing, the first directional input M1 is performed in such a way that the input unit 10 is laterally moved toward a first direction indication location m13. The second directional input M2 is performed in such a way that the input unit 10 is tilted downwards and moved to the direction of a second direction indication location m21, and a second protrusion 72 comes into contact with the base 110. The third directional input M3 is performed in such a way that the input unit 10 is tilted downwards to the direction of a third direction indication location m33, and a third protrusion 73 comes into contact with the base 110.

Data assigned to the above-described first direction indication locations m1, second direction indication locations m2 or third direction indication locations m3 may be variously provided without being limited by the type thereof.

For example, Korean alphabet characters, English alphabet characters, Japanese characters, etc. may be assigned, and symbols, numbers or various types of function commands may be assigned.

When characters are assigned, vowels and consonants may be separated and assigned to different direction indication locations. For example, vowels may be assigned to one of first direction indication locations m1, second direction indication locations m2 and third direction indication locations m3, and consonants may be assigned to the remaining direction indication locations.

Further, Korean alphabet characters, English alphabet characters and Japanese characters may be assigned to the first direction indication locations m1, the second direction indication locations m2 and the third direction indication locations m3, respectively.

In this case, when the number of direction indication locations m1, m2 and m3 and multi-step input are utilized, the number of characters to be assigned may be freely adjusted.

For example, when the number of first direction indication locations m1 is eight, and first directional input M1 is implemented in two steps, 16 characters can be input through the first directional input M1. When the second directional input M2 and the third directional input M3 are configured in the same manner as the first directional input M1, a total of 48 characters can be input.

Meanwhile, it is possible to input characters through the first directional input M1, input numbers through the second directional input M2 and input and execute symbols and various function commands through the third directional input M3.

Here, it should be noted that methods of assigning characters to respective direction indication locations m1, m2, and m3, the number of direction indication locations and determination of whether to input in multiple steps may be variously modified and used according to the circumstances.

Central input C is performed using one or more of a method in which a central input key provided at the center of the input unit 10 is selected and a method in which the entire input unit 10 is moved vertically to the base 110.

As shown in FIG. 2, the central input key 17 is provided at the center of the input unit 10 and is configured to perform central input C while being vertically moved separately from the input unit 10.

Further, as shown in FIG. 18, the central input C may be performed while the entire input unit 10 is vertically moved.

Meanwhile, the central input C may be provided to be performed in two or more steps, that is, in multiple steps. Various methods described in the above first directional input M1 or the like may be used.

Combined central input CM is performed through the combination of central input C with first directional input M1, the combination of central input C with second directional input M2, or the combination of central input C with third directional input M3.

For example, combined central input CM denotes an action of performing first directional input M1 or second directional input M2 while the central input key 17 is being pressed, as shown in FIG. 33. In the case of the data input device of FIG. 18, combined central input CM denotes an action of performing lateral movement, tilting movement or tilting after the entire input unit 10 has moved downwards.

When combined central input CM is performed, characters or function commands different from characters or function commands, which have been originally assigned to the first direction indication locations m1, second direction indication locations m2 or third direction indication locations m3, may be input or executed.

For example, a Korean alphabet letter may be input at the time of independently performing first directional input M1, and an English alphabet letter may be input through the combination of central input C with first directional input M1.

Therefore, the data input device according to the present invention enables the input of new data through combined central input CM, and thus the capacity of input assigned to the first directional input M1, the second directional input M2 and the third directional input M3 may be extended twice.

In this case, the combined central input CM may be implemented to generate different input signals depending on the sequence of the combinations of the respective directional inputs with central input C.

For example, different input signals are generated in the case where central input C is primarily performed and directional input is secondarily performed and the case where directional input is primarily performed and central input C is secondarily performed, respectively.

Further, combined central input CM may be implemented in such a way that the central input C and two or more directional inputs may be combined with each other, for example, in the sequence of first directional input M1, central input C and third directional input M3, or the sequence of second directional input M2, central input C and first directional input M1.

Of course, one or more of the respective input actions constituting the combined central input CM, that is, central input C, first directional input M1, second directional input M2 and third directional input M3, may be implemented in multiple steps.

Meanwhile, the data input device of the present invention may be provided to enable combined directional input MM in which two or more directional inputs are combined with each other to be performed.

The combined directional input MM refers to an action of generating a new input signal when a specific one of first directional input M1, second directional input M2 and third directional input M3 is subsequently performed in the state in which another directional input is performed.

For example, second directional input M2 may be performed in the direction of 3 o'clock in the state in which first directional input M1 is performed in the direction of 12 o'clock. Third directional input M3 may be performed in the direction of 9 o'clock in the state in which second directional input M2 is performed in the direction of 6 o'clock.

Combined directional input MM is provided to input one new piece of data through two or more input actions without sequentially inputting characters assigned to individual input actions.

The combined directional input MM may generate different input signals according to the type of respective directional inputs combined with each other and the sequence of the combinations thereof, or may generate the same input signal when the types of directional inputs combined with each other are identical to each other.

Further, different input signals may also be generated according to the determination of whether to perform respective input actions, constituting combined directional input MM, in multiple steps.

That is, combined directional input MM in which first directional input M1, first-step second directional input M2, and third directional input M3 are combined, and combined directional input MM in which first directional input M1, second-step second directional input M2 and third directional input M3 are combined, may be discriminated from each other.

Meanwhile, two or more input units 10 may be provided on the base 110.

Two input units 10 may be provided on left and right sides of the base 110, or upper and lower sides of the base 110.

In this case, data input methods using the two input units 10 may be more variously implemented. For example, it is possible to input characters through a left input unit 10 and to input numbers, symbols or various function commands through a right input unit 10.

Further, at the time of performing character input, consonants and vowels may be separated and arranged on two input units 10.

Hereinafter, detailed embodiments of the present invention will be described in detail.

FIG. 3 illustrates a data input device according to a first embodiment of the present invention.

Referring to the drawing, an inward input unit 14 is formed in a disk shape and provided to enable third directional input M3 to be performed using press locations provided along the peripheral portion of the top surface thereof.

A movable support unit 43 is provided below the inward input unit 14 and has a top surface having an upwardly curved semicircular shape. The bottom surface of the inward input unit 14 is formed to have the shape corresponding to the top surface of the movable support unit 43 and is configured to perform second directional input while the inward input unit 14 is tilted along the top surface of the movable support unit 43.

In this case, the second directional input M2 is performed by an outward input unit 16 provided along the circumferential portion of the inward input unit 14.

The outward input unit 16 may be divided into portions corresponding to the respective second direction indication locations m2 and provided as a plurality of units, or, alternatively, may be provided in the shape of an integrated ring.

Meanwhile, the section of the upper portion of the outward input unit 16 is formed to be upwardly inclined in a direction from an inward portion to an outward portion, thus enabling tilting to be easily performed.

In this case, such an inclined shape may be an upwardly curved shape, or a downwardly curved shape, as shown in FIG. 35 or 40.

Meanwhile, first directional input M1 is performed in such a way that the entire inward input unit 14, outward input unit 16 and movable support unit 43 are moved toward each first direction indication location m1.

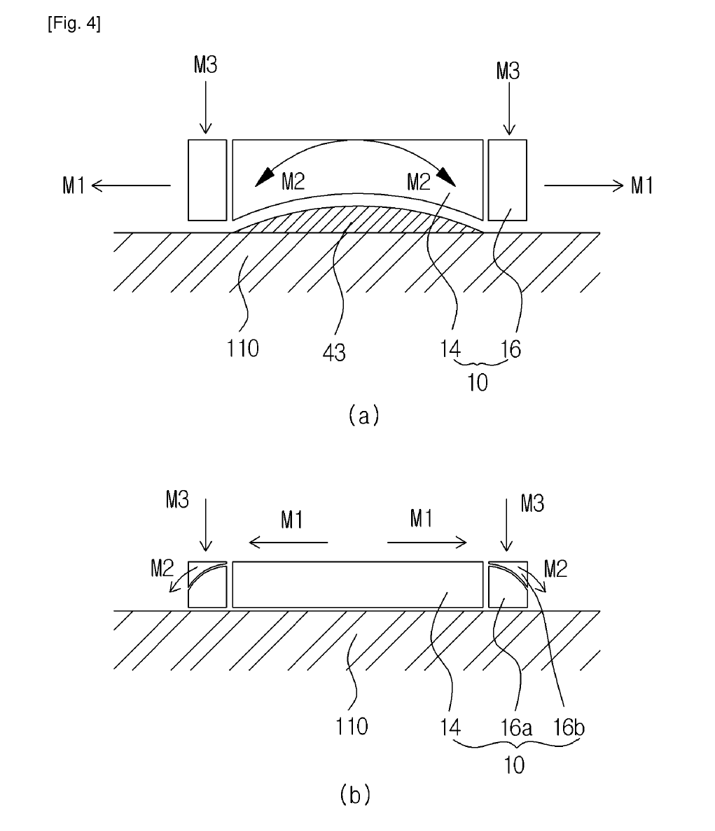

FIG. 4 illustrates a data input device according to a second embodiment of the present invention.

Referring to FIG. 4(a), an outward input unit 16 is provided outside an inward input unit 14 similarly to the first embodiment, and a third detection unit 33 is provided on the outward input unit 16, so that third directional input is performed by pressing the outward input unit 16.

Meanwhile, a second detection unit 32 is provided on the inward input unit 14, so that second directional input is performed by tilting the inward input unit 14 downwards.

Further, first directional input M1 is performed by laterally moving the entire inward input unit 14, outward input unit 16 and movable support unit 43.

Meanwhile, as shown in FIG. 4(b), a first outward input unit 16a and a second outward input unit 16b may be provided outside the inward input unit 14, so that first to third directional inputs may be performed. That is, the first directional input is performed by laterally moving the inward input unit 14, the second directional input is performed by tilting and moving the second outward input unit 16b, and the third directional input is performed by pressing the second outward input unit 16b and enabling the first outward input unit 16a to be pressed together.

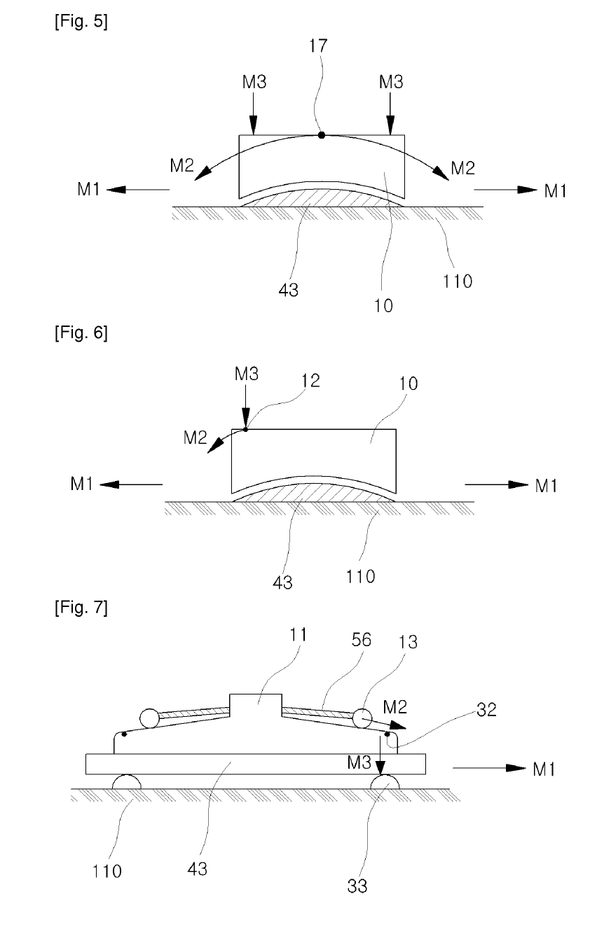

FIG. 5 illustrates a data input device according to a third embodiment of the present invention.

Referring to the drawing, in the present embodiment, a second detection unit 32 and a third detection unit 33 are integrated with each other, so that, when the input unit 10 is tilted downwards to the direction of each second direction indication location m2, the second detection unit 32 is tilted downwards, and thus second directional input M2 is performed, and so that, when each press location located on the peripheral portion of the input unit 10 is pressed, third directional input M3 is performed.

Similarly, when the entire input unit 10 is laterally moved toward each first direction indication location m1, first directional input M1 is performed.

FIG. 6 illustrates a data input device according to a fourth embodiment of the present invention.

Referring to the drawing, even in the present embodiment, a third detection unit 33 for detecting pressing and a second detection unit 32 for detecting tilting are provided to be integrated with each other.

Therefore, when the entire input unit 10 is pushed toward each first direction indication location m1, first directional input M1 is performed. When each press location located on the peripheral portion of the input unit 10 is pressed, third directional input M3 is performed. When the input unit 10 is tilted downwards to the direction of each second direction indication location m2, second directional input M2 is performed.

FIG. 7 illustrates a data input device according to another embodiment of the present invention.

Referring to the drawing, third detection units 33 for detecting pressing are provided below a movable support unit 43 to correspond to respective third direction indication locations m3, and second detection units 32 are provided on the peripheral portion of a first input unit 11 to correspond to respective second direction indication locations m2.

Meanwhile, a ring-shaped second input unit 13 is provided on the top of the first input unit 11, so that, at the time of performing second directional input M2, when the second input unit 13 comes into contact with the second detection units 32 while being tilted downwards along an inclined surface, the second directional input M2 is performed.

Meanwhile, first directional input M1 is performed by laterally moving the entire input unit 10.

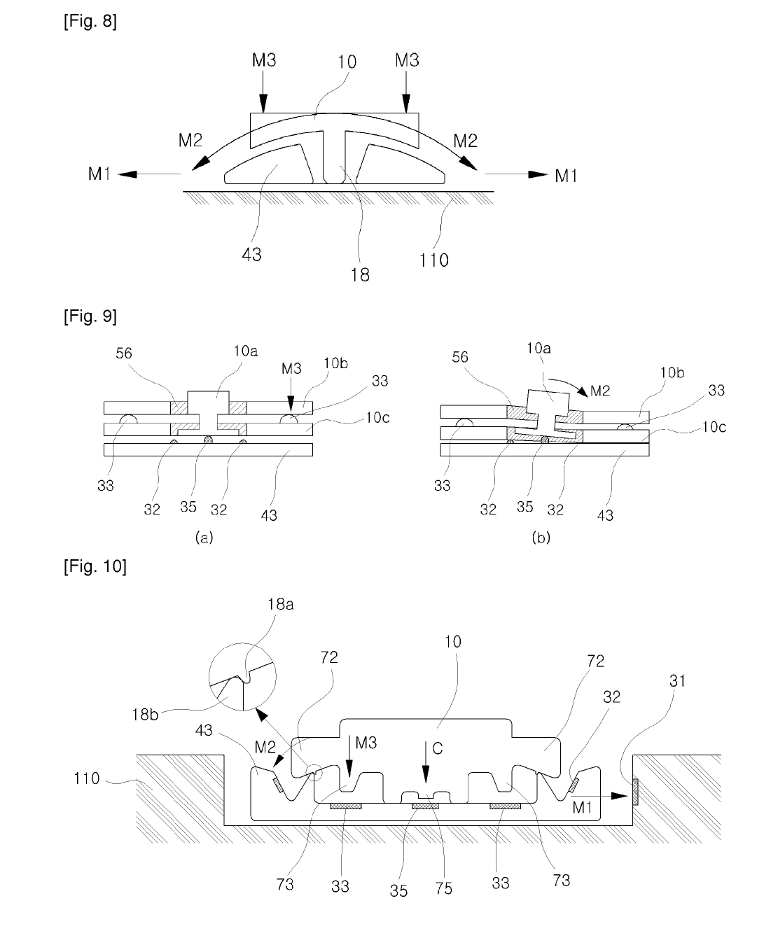

FIG. 8 is a sectional view of a data input device according to a further embodiment of the present invention.

Referring to the drawing, an input unit 10 is formed in the shape of a disk, and a rod-shaped support projection 18, protruding toward a base 110, is provided at the center of the bottom surface of the input unit 10.

Meanwhile, a movable support unit 43 is provided below the input unit 10 such that the support projection 18 is accommodated in the movable support unit 43 to enable tilting. By the movable support unit 43, the reception hole of the movable support unit 43 stably guides the tilting of the support projection 18.

Meanwhile, first directional input M1 is performed by laterally moving the entire input unit 10 and movable support unit 43. Second directional input M2 is performed by tilting the input unit 10. Third directional input M3 is performed by pressing the third direction indication locations of the input unit 10.

FIG. 9 illustrates a data input device according to a fourth embodiment of the present invention.

Referring to the drawing, an input unit 10 includes a central input unit 10a provided in the shape of ‘I’ and disk-shaped upper and lower input units 10b and 10c. The central input unit 10a is connected to the upper and lower input units 10b and 10c by elastic elements 56.

Through this structure, when first directional input M1 is performed, three input units 10a, 10b and 10c are laterally moved together. When second directional input M2 is performed, the central input unit 10a is tilted downwards, and thus this tilting is detected by second detection units 32 provided on the top of a movable support unit 43, thus enabling the second directional input M2.

Meanwhile, third directional input M3 is performed in such a way that, when the upper input unit 10b is pressed, it comes into contact with third detection units 33 provided on the lower input unit 10c, and pressing is detected by the third detection units 33.

FIG. 10 illustrates a detailed embodiment of the present invention.

Referring to the drawing, second protrusions 72 are formed on the outer circumferential portion of an input unit 10, so that, at the time of performing second directional input M2, the second protrusions 72 come into contact with second detection units 32 provided on a movable support unit 43 while being tilted downwards, thus enabling the second directional input M2.

In this case, a support projection stopper 18a is formed on a portion of each second protrusion 72, and a support projection 18b is formed on the movable support unit 43. Accordingly, when the peripheral portion of the input unit 10 is pressed to perform third directional input M3, a relevant second protrusion 72 comes into contact with a relevant second detection unit 32 while being moved downwards, thus preventing second directional input M2 from being performed.

Therefore, the second directional input M2 and the third directional input M3 can be very effectively discriminated from each other by the support projection 18b, thus being performed.

Meanwhile, third protrusions 73 are formed on the bottom surface of the input unit 10 along the peripheral portion of the bottom surface. Third detection units 33, which come into contact with the third protrusions 73 while the third protrusions 73 are moved downwards at the time of performing third directional input M3, are provided on the top surface of the movable support unit 43 corresponding to the third protrusions 73.

Further, a third protrusion 73, protruding toward a central input detection unit 35 provided on the movable support unit 43 to perform central input C, is provided at the center of the bottom surface of the input unit 10.

First directional input M1 is performed in such a way that the entire input unit 10 and movable support unit 43 are laterally moved. In order to detect such lateral movement, first detection units 31 for detecting contact with the movable support unit 43 are provided on the inner circumferential portion of the base 110.

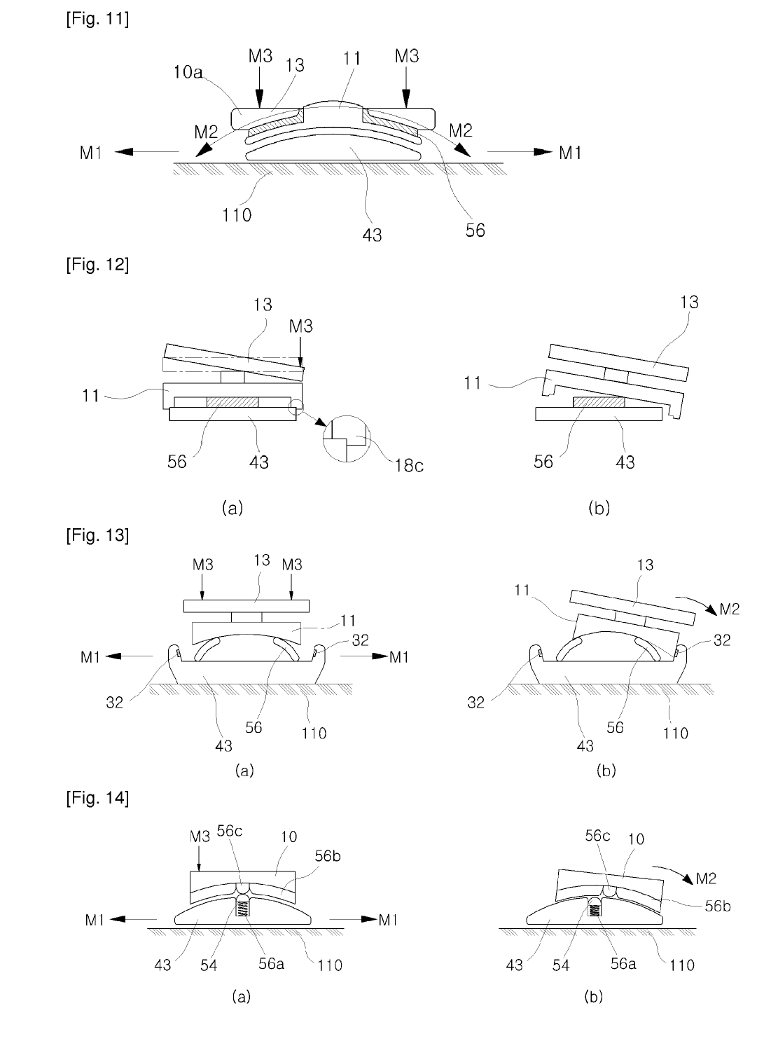

FIG. 11 illustrates a data input device according to yet another embodiment of the present invention.

Referring to the drawing, an input unit 10 includes a cover-shaped first input unit 11, the bottom surface of which is curved, and a plurality of second input units 13 provided on the top surface of the first input unit 11 along the peripheral portion of the top surface.

Of course, the second input units 13 may be connected to each other and formed in the shape of an integrated ring.

Through this structure, second directional input M2 is performed by simultaneously tilting the first input unit 11 and the second input units 13 downwards, and third directional input M3 is performed by pressing each second input unit 13.

In this case, elastic elements 56 are provided between the first input unit 11 and the second input units 13, thus functioning to return the second input units 13 to their original positions after performing third directional input M3 while functioning to discriminate the second directional input M2 from the third directional input M3.

FIG. 12 illustrates a data input device according to yet another embodiment of the present invention.

Referring to the drawing, the input unit 10 includes a first input unit 11 for performing second directional input M2 by tilting, and a second input unit 13 provided on the top of the first input unit 11 and configured to perform third directional input M3 by tilting or pressing.

Through this structure, when third directional input M3 is performed, the first input unit 11 is maintained in a horizontal state and only the second input unit 13 is tilted (or pressed), as shown in FIG. 12(a). When second directional input M2 is performed, the first input unit 11 and the second input unit 13 are simultaneously tilted downwards, as shown in FIG. 12(b).

In this case, a tilting stop projection 18c is further provided on the circumferential portion of the first input unit 11 to prevent the first input unit 11 from being tilted at the time of performing third directional input M3.

Therefore, in the case of pressing (third directional input M3), tilting (second directional input M2) is restricted due to the tilting stop projection 18c. If the first input unit 11 is tilted downwards to the direction of each second direction indication location m2 at the time of performing only second directional input M2, tilting is performed while the tilting stop projection 18c is released (or removed).

The above-described construction facilitates the discrimination between second directional input M2 and third directional input M3 in the above-described third embodiment.

FIG. 13 illustrates a data input device to describe the third embodiment in more detail.

Referring to the drawing, the performance of second directional input M2 and third directional input M3 is implemented in the same method as the above-described third embodiment. However, in the present embodiment, the first input unit 11 is moved downwards while elastic elements 56, provided below the first input unit 11, are elastically deformed at the time of performing a tilting operation.

This structure is more effective when the first input unit 11 is laterally moved in a predetermined direction and is then tilted downwards in a direction opposite the movement direction. For example, in the case where a three-dimensional game is executed using the data input device of the present invention, when the movement of a game character is manipulated by the lateral movement of the input unit 10, and the processing of the eyes of the game character is manipulated by the tilting of the input unit 10, the first input unit 11 may be used when the game character is intended to be tilted in a south direction at the time of looking up at the sky while moving in a north direction.

In FIG. 14, in the data input device of the present invention, the construction for discriminatively performing second directional input M2 based on tilting and third directional input M3 based on pressing is shown.

Referring to the drawing, a third elastic element 56c is provided on the bottom of an input unit 10, and a projection 54, a first elastic element 56a and a third elastic element 56c are provided on a movable support unit 43. Accordingly, when third directional input M3 based on pressing is performed, the projection 54 is caught due to the difference between the heights of second elastic elements 56b and the third elastic element 56c, thus preventing tilting from being performed. When second directional input M2 is performed, the input unit 10 is pressed downwards to allow the projection 54 to be received in the movable support unit 43, and the second elastic elements 56b are elastically deformed to reduce the difference between the heights of the second elastic elements 56b and the third elastic element 56c, thus enabling the input unit 10 to be tilted downwards without being restricted by the projection 54.

Meanwhile, the above-described construction has an advantage of providing an impression of clicking at the time of tilting the input unit 10 downwards, in addition to an advantage of discriminating tilting from pressing.

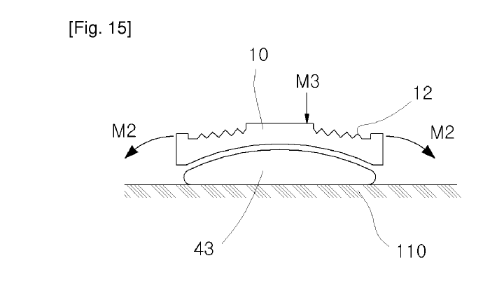

FIG. 15 illustrates an embodiment in which a press point corresponding to third directional input M3 is slightly different from a tilt point corresponding to second directional input M2 in the above fourth embodiment.

Referring to the drawing, an input unit 10 is configured such that crumples are formed at a predetermined thickness on the top of the input unit around a center portion. Therefore, when third directional input M3 is performed, the crumpled portion of the input unit 10 is pressed. When second directional input M2 is performed, the crumpled portion is pressed, and thus the input unit 10 is tilted downwards.

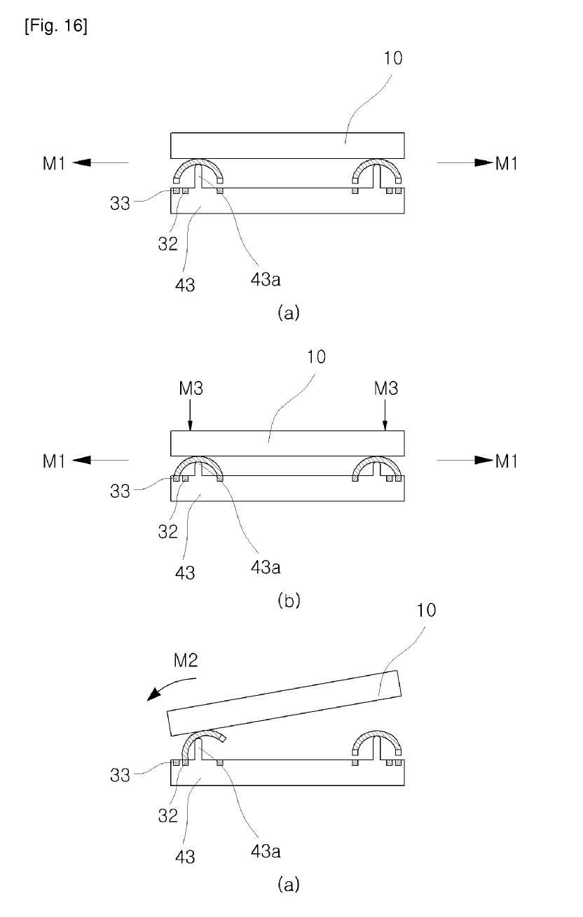

In FIG. 16, a data input device in which a tilt point corresponding to second directional input M2 and a press point corresponding to third directional input M3 are identical to each other is shown.

Referring to the drawing, elastic projections 43a are formed on a movable support unit 43 toward the input unit 10, and upwardly curved-semicircular support units 43b are provided between the elastic projections 43a and the input unit 10.

Therefore, as shown in FIG. 16(b), at the time of performing third directional input M3, a relevant semicircular support unit 43b is moved downwards on a relevant elastic projection 43a and comes into contact with a third detection unit 33 due to pressing pressure. At the time of performing second directional input M2, the semicircular support unit 43b comes into contact with a second detection unit 32 while rotating at a predetermined angle in the direction of the tilting of the input unit 10.

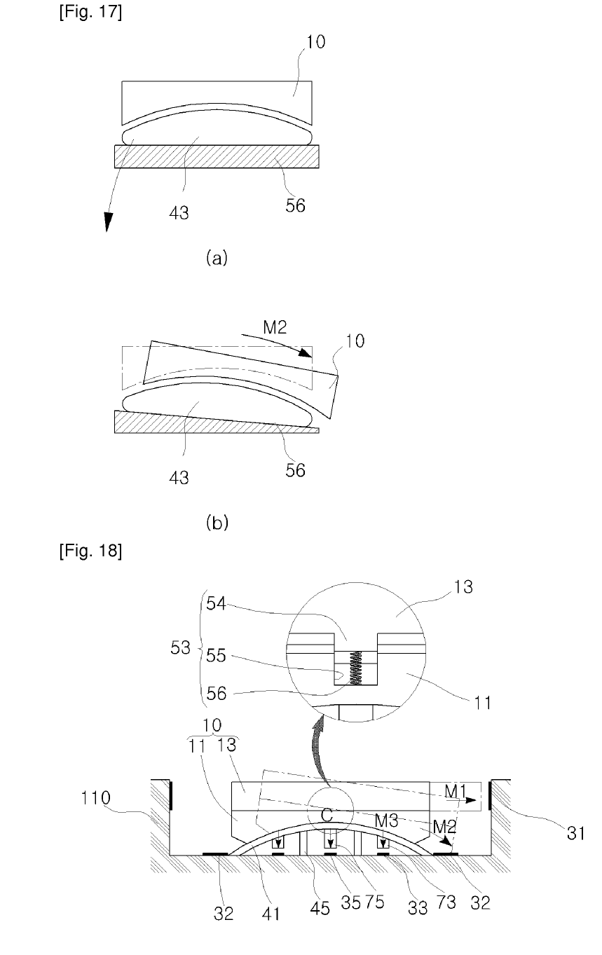

FIG. 17 illustrates an example in which an elastic element 56 is disposed below a movable support unit 43, so that, when the input unit 10 is pressed in a predetermined direction at the time of performing third directional input M3, the movable support unit 43 itself is tilted more by the elastic element 56. In this case, the movable support unit 43 is spaced apart from a base 110 by a predetermined interval, so that, when second directional input M2 is performed together with first directional input M1 in a direction opposite that of the first directional input M1, for example, when tilting is performed in a south direction in the state in which the input unit 10 is moved in a north direction, the second directional input M2 can be more easily performed.

FIG. 18 illustrates a data input device according to yet another embodiment of the present invention.

Referring to the drawing, a hemispheric support unit 41, curved toward an input unit 10, is provided between the bottom of the input unit 10 and a base 110.

In this case, the input unit 10 has a bottom contact surface corresponding to the top surface of the support unit 41, and includes a first input unit 11 tilted and moved along the support unit 41, and a second input unit 13 placed on the top surface of the first input unit 11 and configured to be laterally moved along the top surface of the first input unit 11.

That is, the first input unit 11 has a bottom surface formed in a shape corresponding to the curved surface of the support unit 41, and is configured to perform tilting movement while moving along the curved surface. The first input unit 11 has a top surface formed as a flat surface to enable the lateral movement of the second input unit 13.

Here, the top surface of the first input unit 11 may be formed in various shapes as long as the shapes enable the lateral movement of the second input unit 13. For example, the top surface of the first input unit 11 may be formed to be concave, thus preventing the second input unit 13 from being moved relative to the first input unit 11 unless a user intends to slip (laterally move) the second input unit 13 at the time of tilting the first input unit 11. In this case, in order to laterally move the second input unit 13, the second input unit 13 may be moved after having become removed at a predetermined distance from the first input unit 11.

Therefore, at the time of performing second directional input M2, the first input unit 11 and the second input unit 13 are tilted downwards and moved together with each other. However, at the time of performing second directional input M2, the first input unit 11 is not moved, and only the second input unit 13 is laterally moved on the first input unit 11.

Third protrusions 73, which are protruded to correspond to third direction indication locations m3 and are configured to move and come into contact with third detection units 33 at the time of performing third directional input M3, are provided on the bottom of the support unit 41.

Further, a central protrusion 75, which is protruded toward the base 110 to correspond to the center of the center of the input unit 10 and is configured to come into contact with a central input detection unit 35 at the time of performing central input C, is provided on the bottom of the support unit 41.

First detection units 31 are arranged on the inner circumferential portion of the base 110 to correspond to the respective first direction indication locations m1 so that the circumferential portion of the second input unit 13 comes into contact with the first detection units 31 at the time of the lateral movement of the second input unit 13.

The second detection units 32 are arranged on the bottom surface of the base 110 to correspond to the respective second direction indication locations m2 so that the circumferential portion of the first input unit 11 comes into contact with the second detection units 32 at the time of performing the tilting movement of the first input unit 11.

In this case, the data input device may further include an input switching unit 53 disposed between the first input unit 11 and the second input unit 13 and configured to selectively perform the tilting movement of the first input unit 11 or the lateral movement of the second input unit 13.

The input switching unit 53 may be provided in various forms. For example, as shown in FIG. 18, one or more reception holes 55 may be formed at the center or another single portion of the top of the first input unit 11, projections 54 may be formed on the bottom surface of the second input unit 13 corresponding to the reception holes 55, and elastic elements 56 for pushing the projections 54 out of the reception holes 55 may be provided between the projections 54 and the reception holes 55.

Therefore, at the time of performing first directional input M1, the projections 54 are pushed out by the elastic elements 56 and are located outside the reception holes 55, thus enabling the second input unit 13 to be moved laterally to the first input unit 11. At the time of performing second directional input M2, when the second input unit 13 is downwardly pressed, and the projections 54 are received in the reception holes 55, the second input unit 13 is fixed to the first input unit 11, and thus the first input unit 11 and the second input unit 13 can be simultaneously tilted downwards and moved.

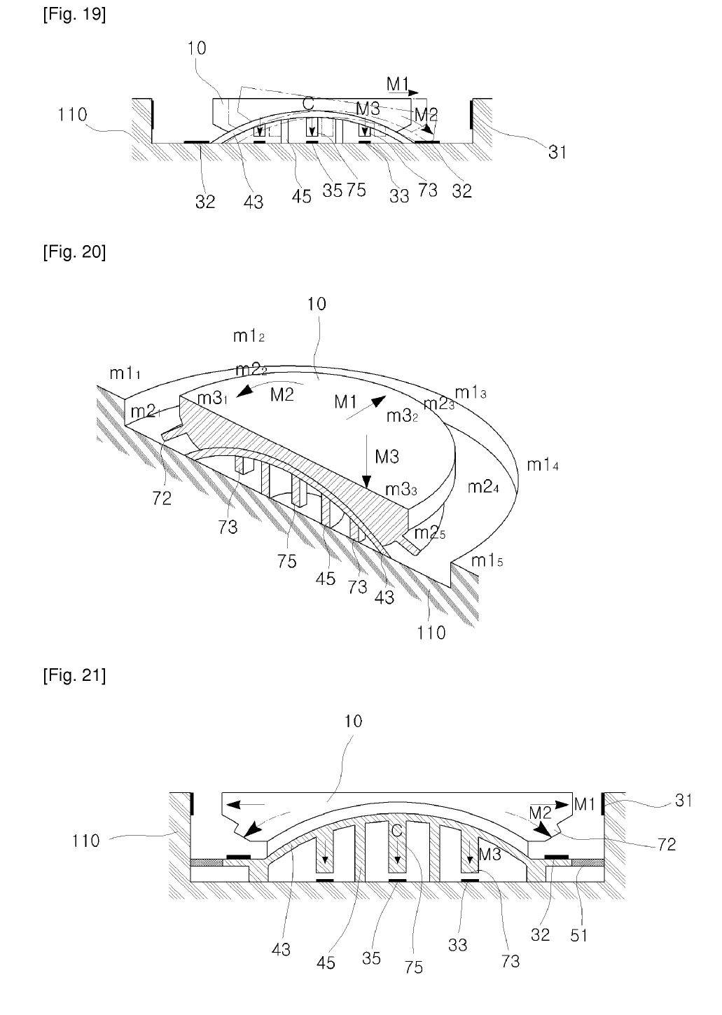

FIGS. 19 to 21 illustrate a data input device according to various embodiments of the present invention.

Referring to the drawings, the data input device of the present invention has a movable support unit 43 which is disposed between the bottom of an input unit 10 and a base 110 and is configured to have a hemispheric shape, curved toward the input unit 10, and to be laterally moved together with the input unit 10 at the time of performing first directional input M1

The movable support unit 43 in the present embodiment is different from the support unit 41 in the embodiment of FIG. 18 in that the movable support unit 43 is laterally moved together with the input unit 10 at the time of performing first directional input M1

Third protrusions 73, protruding toward third detection units 33 arranged on the base 110, and a central protrusion 75 protruding toward a central input detection unit 35, are formed on the bottom of the movable support unit 43.

In this case, the input unit 10 has a bottom contact surface corresponding to the shape of the top surface of the movable support unit 43, and is tilted and moved along the movable support unit 43, and thus second directional input M2 is performed.

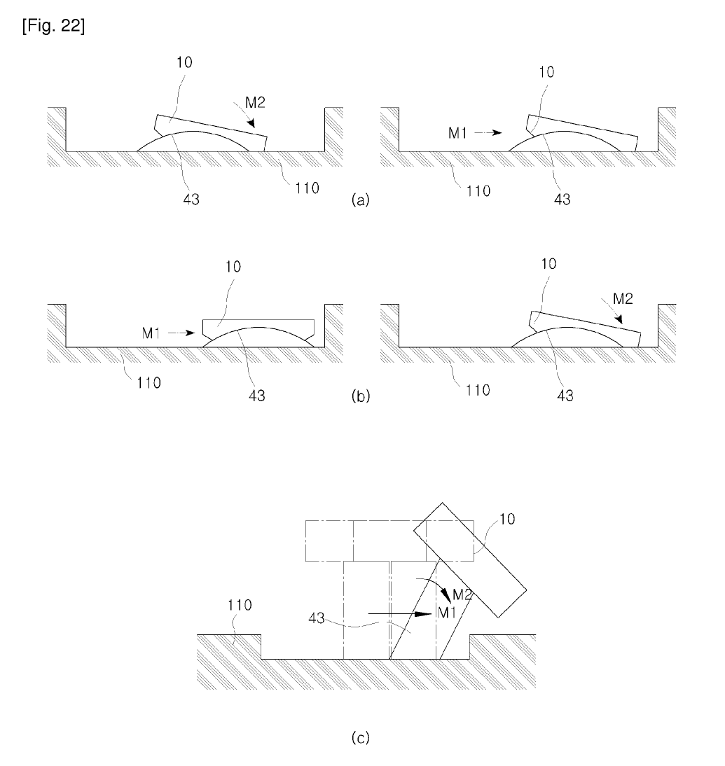

Referring to FIG. 22, a data input device according to the present embodiment is provided to enable first directional input M based on the lateral movement of the input unit 10 and second directional input M2 based on the tilting movement of the input unit 10 to be independently and sequentially or simultaneously performed.

That is, FIG. 22 (a) shows a process in which second directional input M2 is primarily performed in such a way as to tilt and move the input unit 10, and then first directional input M1 is performed in such a way as to laterally move the input unit in the state in which the input unit is tilted and moved. FIG. 22(b) shows a process in which first directional input M1 is primarily performed by the lateral movement of the input unit 10, and then second directional input M2 is performed by the tilting movement of the input unit 10.

FIG. 22(c) illustrates an example of the lateral movement and tilting movement of the input unit 10 supported by a stick-shaped support unit 43, and shows that lateral movement and tilting movement defined in the present specification may be variously modified regardless of the detailed shape of the support unit 43 or the input unit 10.

On the circumferential portion of the input unit 10, second protrusions 72 protruding toward second detection units 32 to correspond to respective second direction indication locations m2 may be further provided.

In this case, an input switching unit 53 for preventing the input unit 10 from being tilted and moved on the movable support unit 43 at the time of performing first directional input M1 may be further provided. The input switching unit 53 may be implemented in various forms, for examples, in the same form as that of the above second embodiment.

On the circumferential portion of the input unit 10, the second protrusions 72 may be further provided, as shown in FIGS. 20 and 21. Further, the second detection units 32 may also be provided on the movable support unit 43 rather than the base 110, as shown in FIG. 21.

Meanwhile, as shown in FIG. 21, the data input device may further include return elements 51 disposed between the movable support unit 43 and the base 110 and configured to return both the input unit 10 and the movable support unit 43 to the reference location S at the time of performing first directional input M1.

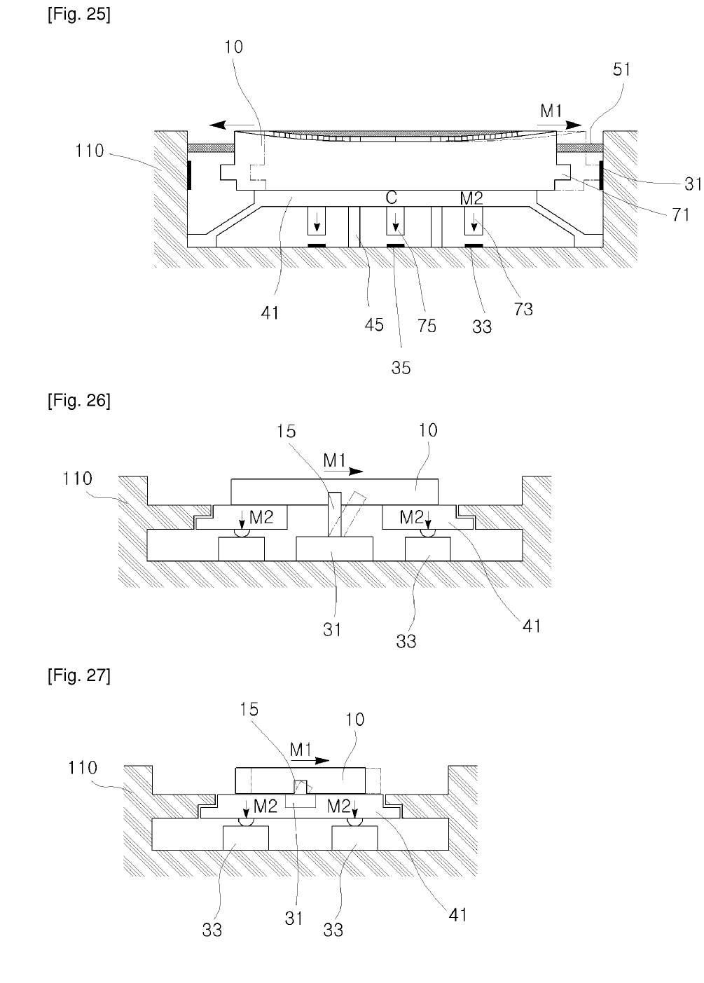

Referring to FIG. 25, a data input device according to the present invention includes a base 110, an input unit 10 provided on the base 110 and configured to enable first directional input M1, third directional input M3 and central input C to be independently performed, a support unit 41 provided between the bottom of the input unit 10 and the base 110 and configured to support the lateral movement and tilting of the input unit 10, first detection units 31 for detecting the first directional input M1, third detection units 33 for detecting the third directional input M3, a central input detection unit 35 for detecting the central input C, and a control unit.

In this case, the first directional input M1 is performed in such a way that the input unit 10 is laterally moved along the top surface of the support unit 41, and third directional input M3 is performed in such a way that third protrusions 73 provided on the bottom of the support unit 41 come into contact with the third detection units 33 by the tilting of the input unit 10.

Meanwhile, the central input C in the present embodiment is performed in such a way that the input unit 10 is moved vertically to the base 110.

The support unit 41 includes a central protrusion 75 protruding from the center of the input unit 10 toward the base 110, and third protrusions 73 protruding from the locations corresponding to respective third direction indication locations m3 toward the base 110.

The first detection units 31 are provided along the inner circumferential portion of the base 110 to correspond to respective first direction indication locations m1 and configured to detect contact with the input unit 10 at the time of performing first directional input M1.

Here, the data input device may further include first protrusions 71 formed to protrude toward the respective first detection units 31 along the circumferential portion of the input unit 10.

Further, return elements 51 for returning the input unit 10 to the reference location S at the time of performing first directional input M1 may be further provided between the input unit 10 and the base 110.

The third detection units 33 detect contact with the third protrusions 73 at the time of performing third directional input M3, and the central input detection unit 35 detects contact with the central protrusion 75 at the time of performing central input C.

Referring to FIGS. 26 and 27, the data input device of the present invention includes a base 110, an input unit 10 provided on the base 110 and configured to enable first directional input M1 and third directional input M3 to be independently performed, a support unit 41 provided between the bottom of the input unit 10 and the base 110 and configured to support the lateral movement and the tilting of the input unit 10, a rod 15, one end of which is extended to the bottom of the input unit 10, a first detection unit 31 provided at the other end of the rod 15 and configured to detect the movement direction of the rod 15 caused by the lateral movement of the input unit 10, third detection units 33 provided below the support unit 41 to correspond to respective third direction indication locations m3 and configured to come into contact with the support unit 41 at the time of performing third directional input M3, and a control unit.

In the present embodiment, the first directional input M1 is performed in such a way that the input unit 10 is laterally moved along the top surface of the support unit 41.

In this case, since the bottom of the input unit 10 is connected to one end of the rod 15, the movement direction of the input unit 10 is transmitted to the first detection unit 31 through the rod 15 when the input unit 10 is moved in a predetermined direction.

Meanwhile, the support unit 41 is provided to support the lateral movement and tilting (or pressing) of the input unit 10.

The support unit 41 may be provided in various shapes, for example, in a ring shape, as shown in FIG. 26, in a fan-shaped plate divided into respective third direction indication locations m3, or in a disk shape, as shown in FIG. 27.

Therefore, when the input unit 10 is tilted downwards or pressed to the direction of a predetermined third direction indication location m3, the support unit 41 is tilted downwards or pressed together with the input unit 10, and a corresponding third detection unit 33 located below the support unit 41 detects such tilting or pressing.

Meanwhile, when the support unit 41 is provided in the shape of the divided plate, the support unit 41 is pressed by the tilting of the input unit 10 and is moved downwards along with press parts, thus coming into contact with a corresponding third detection unit 33.

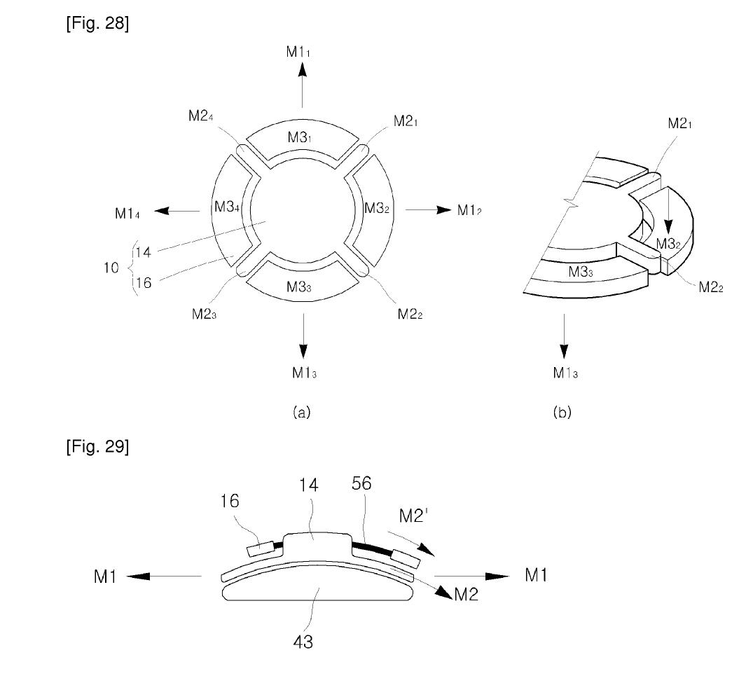

FIG. 28 illustrates a data input device according to yet another of the present invention.

In the present embodiment, first directional input M1 is performed by the lateral movement of an input unit 10 and both second directional input M2 and third directional input M3 are performed by the pressing of the input unit 10, unlike the above-described embodiment.

The input unit 10 may include an inward input unit 14 in which four extension parts are formed in an ‘X’ shape, and four outward input units 16 provided between the respective extension parts.

By way of this structure, at the time of performing first directional input M1, the entire inward input unit 14 and outward input units 16 are laterally moved. At the time of performing second directional input M2, the respective extension parts of the inward input unit 14 are pressed. At the time of performing third directional input M3, the outward input units 16 are pressed.

Here, the second directional input M2 and the third directional input M3 may be performed by simultaneously pressing the extension parts of the inward input unit 14 and the outward input units 16. Accordingly, it is possible to press an outward input unit 16 in one direction at the same time that second directional input M2 is performed by pressing the inward input unit 14 in another direction in the lateral movement state of the inward input unit.

FIG. 29 illustrates a data input device according to yet another of the present invention.

The data input device in the present embodiment performs first directional input M1 by the lateral movement of an inward input unit 14, performs second directional input M2 by the tilting of the inward input unit 14, and performs third directional input M3 by the tilting of the outward input units 16, respectively.

That is, the third directional input M3 is performed by tilting the outward input units 16 (refer to the right side of FIG. 29) provided on the peripheral portion of the top of the inward input unit 14.

Here, elastic elements 56 function to return the outward input units 16 to their original positions after the performance of third directional input M3 while functioning to discriminate second directional input M2 from third directional input M3.

FIG. 30 illustrates a data input device according to yet another of the present invention.

Referring to the drawing, first directional input is performed in such a way that a disk-shaped first input unit 11 is laterally moved in forward/backward directions and left/right directions. Second directional input M2 is performed in such a way that a star-shaped second input unit 13, provided on the first input unit 11, is tilted downwards to the direction of each projection, and third directional input M3 is performed in such a way that the second input unit 13 is pressed.

In this case, the second input unit 13 may have a variable number of projections. For example, when the second input unit 13 has five projections, as shown in the drawing, five input signals may be generated by each of pressing, movement and tilting.

Therefore, when the input unit 10 is provided in two sets, a total of 30 input signals may be generated.

Further, even if the number of projections is identical, the number of tilting actions and the number of pressing actions may differ. For example, in the case shown in the drawing, third directional input M3 based on pressing may be performed using only four projections excluding any one projection, and second directional input M2 may be performed using all the five projections.

Meanwhile, the directions of the projections of the second input unit may be variously provided.

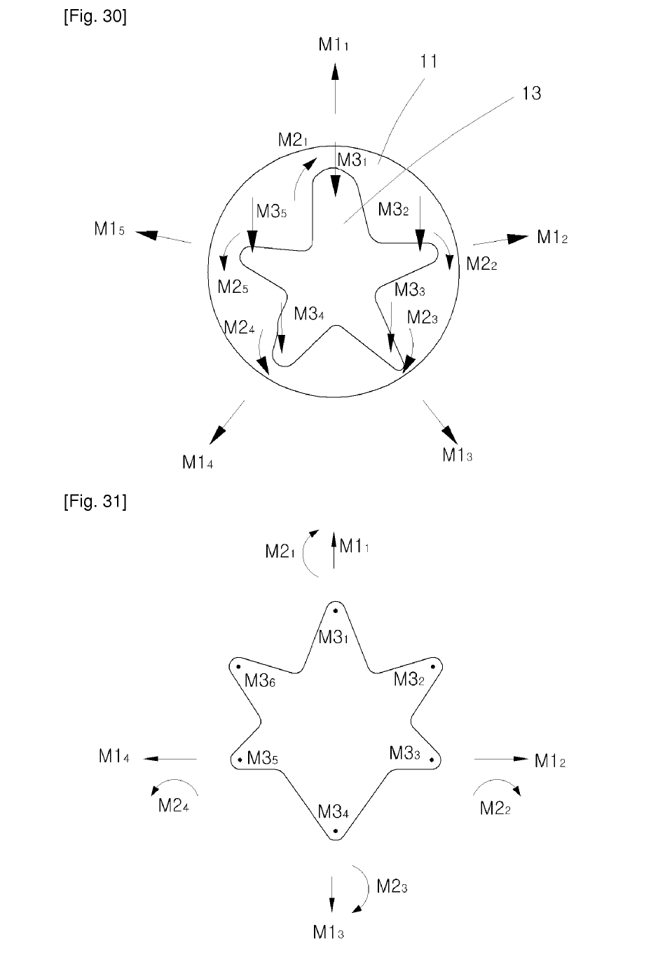

For example, as shown in FIG. 31, two projections corresponding to the northeast direction and the northwest direction are added to four projections corresponding to the west, east, south and north directions, and thus a total of six projections may be provided.

In this case, the movement of a game character may be performed by lateral movement conducted in the directions of four projections, that is, the east, west, south and north directions, the processing of eyes of the game character may be performed by tilting (second directional input M2) conducted in the directions of four projections, that is, the east, west, south and north directions, and various operation commands may be executed by pressing (third directional input M3) conducted in the directions of respective projections.

Of course, the above-described operation examples related to the respective directional inputs may be varied or replaced according to the circumstances.

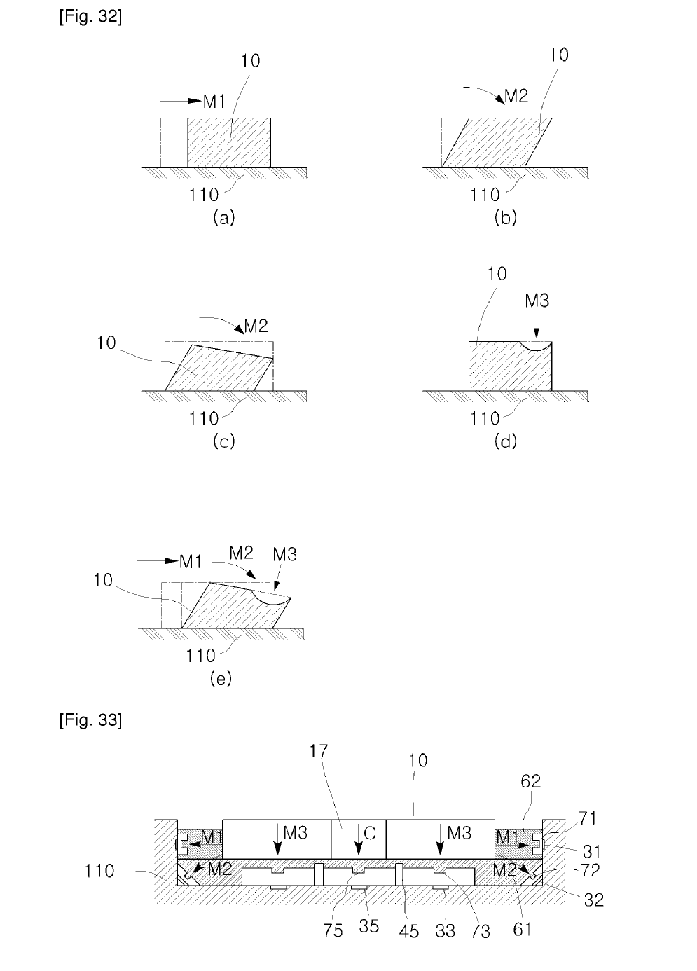

FIG. 32 illustrates a data input device according to yet another embodiment of the present invention.

The data input device in the present embodiment is configured such that an input unit 10 is provided in a gel type enabling the input of signals attributable to the elastic deformation thereof.

Therefore, first directional input M1 is performed by the lateral movement of the entire or partial input unit 10, as shown in FIGS. 32(a) and 32(b), second directional input M2 is performed by the tilting of the input unit 10, and third directional input M3 is performed by the deformation of one region on the top of the input unit 10 attributable to pressing.

Meanwhile, FIG. 32(e) illustrates an example in which first directional input M1, second directional input M2 and third directional input M3 are simultaneously performed.

FIG. 33 illustrates a modification of the above-described gel-type data input device.

Referring to the drawing, the data input device includes a first elastic part 61 and a second elastic part 62.

The first elastic part 61 is disposed between the bottom of an input unit 10 and a base 110, and configured to support the input unit 10 so that the input unit 10 is laterally moved along the top surface of the first elastic part 61, and to return the input unit 10 to its initial position at the time of the tilting movement of the input unit 10.

The top surface of the first elastic part 61 is provided to be flat, so that the input unit 10 is placed thereon to be laterally movable.

Therefore, the input unit 10 may be moved to each first direction indication location m1 along the top surface of the first elastic part 61.

Meanwhile, the second elastic part 62 is disposed between the circumferential portion of the input unit 10 and the base 110 and configured to return the input unit 10 to its initial position at the time of the lateral movement of the input unit 10.

Here, the first elastic part 61 and the second elastic part 62 may be made of various materials and formed in various shapes.

First detection units 31 are provided on the inner circumferential portion of the base 110 to correspond to respective first direction indication locations m1.

Meanwhile, first protrusions 71 protruding to correspond to respective first detection units 31 are provided on the circumferential portion of the second elastic part 62. The first protrusions 71 are moved (pressed) by the input unit 10 and come into contact with the first detection units 31 at the time of lateral movement of the input unit 10.

Further, when the first detection units 31 are implemented as pressure sensors, the space between the input unit 10 and the base 110 is filled with the second elastic part 62 without the first protrusions 71 being separately formed, thus enabling the detection of pressing pressure, transmitted through the second elastic part 62 at the time of lateral movement of the input unit 10.

Second detection units 32 corresponding to respective second direction indication locations m2, third detection units 33 corresponding to respective third direction indication locations m3, and a central input detection unit 35 corresponding to the bottom of a central input key 17 are arranged on the base 110.

Second protrusions 72 protruding to correspond to respective second detection units 32 are provided on the lower circumferential portion of the first elastic part 61.

Therefore, when the input unit 10 is tilted and moved, the second protrusions 72 are moved (pressed) by the input unit 10, and then come into contact with the second detection units 32. After second directional input M2 has been performed, the input unit 10 is returned to its initial position by the elastic force of the first elastic part 61.

Third protrusions 73 protruding to correspond to respective third detection units 33 are provided on the bottom of the first elastic part 61. The third protrusions 73 are moved (pressed) by the input unit 10 and come into contact with the third detection units 33 at the time of tilting the input unit 10.

Meanwhile, a central protrusion 75 protruding to correspond to the bottom of the central input key 17 is provided on the bottom of the first elastic part 61. The central protrusion 75 is moved toward and comes into contact with the central input detection unit 35 at the time of performing central input C.

In this case, a support element 45 for preventing the respective protrusions from coming into contact with the detection units when in a state of not being used may be further provided between the central protrusion 75 and the third protrusions 73. The support element 45 may be preferably implemented to include an elastic material so that it is distorted at the time of performing central input C or third directional input M3.

Meanwhile, the data input device according to the present invention may be utilized in various areas as well as for the input of data such as characters, numbers and symbols.

For example, a three-dimensional graphic operation (for example, an operation of producing a three-dimensional object shape using various types of design programs) may be performed using the data input device of the present invention.

For example, referring to FIG. 23, through first directional input M1, the forward/backward and left/right movement of a subject, such as the dragging of a mouse, may be performed, and through third directional input M3₁ in left/right directions, the enlargement and reduction of the subject may be performed.

Further, through third directional input M3₂ in forward/backward directions, the clockwise or counterclockwise planar rotation of a subject may be performed by using a normal line of the plane of a monitor as a shaft, and through the second directional input M2, the three-dimensional rotation of the subject may be performed.

In this case, a plurality of touch detection units 37 may be provided along the peripheral portion of the top of the input unit 10. The planar rotation may be performed according to the direction of continuous touching (refer to R) of the touch detection units 37.

Further, the input unit 10 may be provided to be rotatable in left/right directions (refer to R) by using a normal line of the plane of the base 110, passing through the reference location S, as a shaft, so that the planar rotation of the subject may be performed by the rotation of the input unit 10.

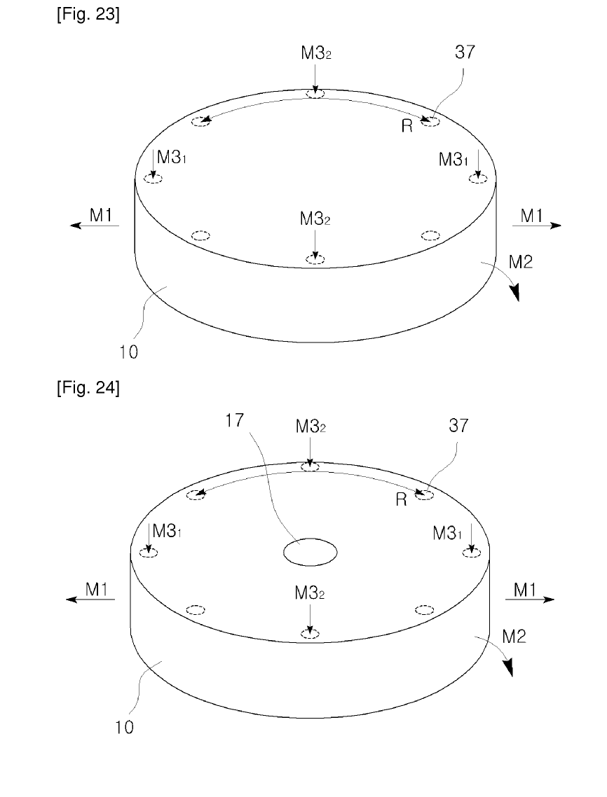

As another utilization example, it is possible to perform a three-dimensional map search operation, such as the three-dimensional Google Earth, using the data input device of the present invention. Referring to FIG. 24, through first directional input M1, the movement of a mouse pointer may be performed.

Further, through third directional input M3₁ in left/right directions, the manipulation of left/right buttons of a mouse may be performed. Through third directional input M3₂ in forward/backward directions, the enlargement or reduction of a map may be performed, and through second directional input M2, the three-dimensional tilting of the map may be performed.

In this case, when first directional input M1 is performed in the state in which central input C is performed, the movement of the map (that is, dragging performed with the left button of the mouse pressed) may be performed.

Meanwhile, even in this case, a plurality of touch detection units 37 may be provided along the peripheral portion of the top of the input unit 10. The clockwise or counterclockwise planar rotation of the map may be performed according to the direction of continuous touching of the touch detection units 37.

Further, the input unit 10 may be provided to be rotatable in left/right directions by using a normal line of the plane of the base 110, passing through the reference location S, as a shaft, so that the clockwise or counterclockwise planar rotation of the map may be performed by the rotation of the input unit 10.

Here, it should be noted that the above two embodiments are only detailed utilization examples of the data input device according to the present invention, and the present invention can be applied to various fields, and that detailed operational functions and input actions may be variously modified in the above embodiments.

Meanwhile, in the data input device of the present invention, pressure sensors or sensing pads, which are capable of detecting lateral movement, tilting movement, and directional pressing (third directional input M3) regardless of whether an actually operating input unit 10 is provided or not, are implemented as detection units, so that, even if the actual operation of the input unit 10 does not occur, first directional input M1, second directional input M2 and third directional input M3 according to the present invention may be performed.

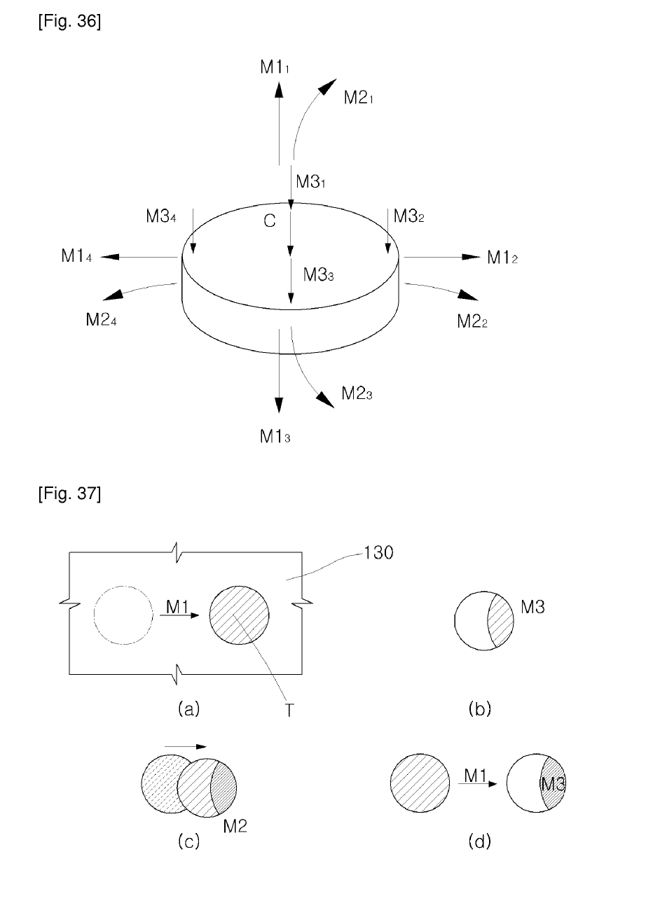

Further, as shown in FIG. 36, the data input device of the present invention may be utilized as a mouse. For example, the movement of a mouse pointer may be performed through first directional input M1.

Further, window view, window enlargement/reduction, background image view, window open/close functions, etc. are performed through the second directional input M2 in the direction of 12 and 6 o'clock, and a window turn function may be performed through the second directional input M2 in the direction of 3 or 9 o'clock.

Further, scroll up/down manipulation may be performed through the third directional input M3 in the direction of 12 and 6 o'clock, a mouse right button function may be performed through the third directional input M3 in the direction of 3 o'clock, and a scroll wheel function may be performed through the third directional input M3 in the direction of 9 o'clock.

Further, central input C may be implemented in multiple steps to enable the function of double-clicking of the left button of the mouse to be performed through second-step central input.

In this case, it is apparent that functions assigned to the second directional input M2 and the third directional input M3 may be varied and exchanged with each other.

Meanwhile, the data input device according to the present invention may also be operated on a touch screen 130, as shown in FIGS. 37 and 45 to 47.

FIG. 37 shows an action in which a touch screen 130 capable of detecting pressure detects the directional movement, pressing or tilting of a contact point T of a finger or an input unit 10 from a reference location S and performs each input action.

In more detail, as shown in FIG. 37(a), first directional input M1 is implemented by detecting the movement of the contact point T of the finger (or the input unit 10, the same as follows).

Third directional input M3 is implemented by detecting a location at which pressing has occurred based on a contact area, that is, variation in the contact area, as a directional press value, as shown in FIG. 37(b).

In this case, it is apparent that the third directional input M3 may be detected at any location even after the contact point T attributable to first directional input M1 has been moved.

Second directional input M2 is implemented in such a way that, when the contact point T of the finger is moved by a predetermined distance and a predetermined pressing pressure is generated, this pressing pressure is detected, as shown in FIG. 37(c).

However, the pressing pressure generated in a predetermined direction is different from a detected pressure value generated at the time of performing third directional input M3. At the time of performing third directional input M3, a pressing pressure is generated in a predetermined portion, but, at the time of performing second directional input M2, a pressing pressure is generated in a wider contact area than that of the pressing pressure of the third directional input M3.

Further, tilting movement (second directional input M2) or pressing (third directional input M3) may be detected when a contact area is pressed while being varied, that is, while part of the contact area disappears.

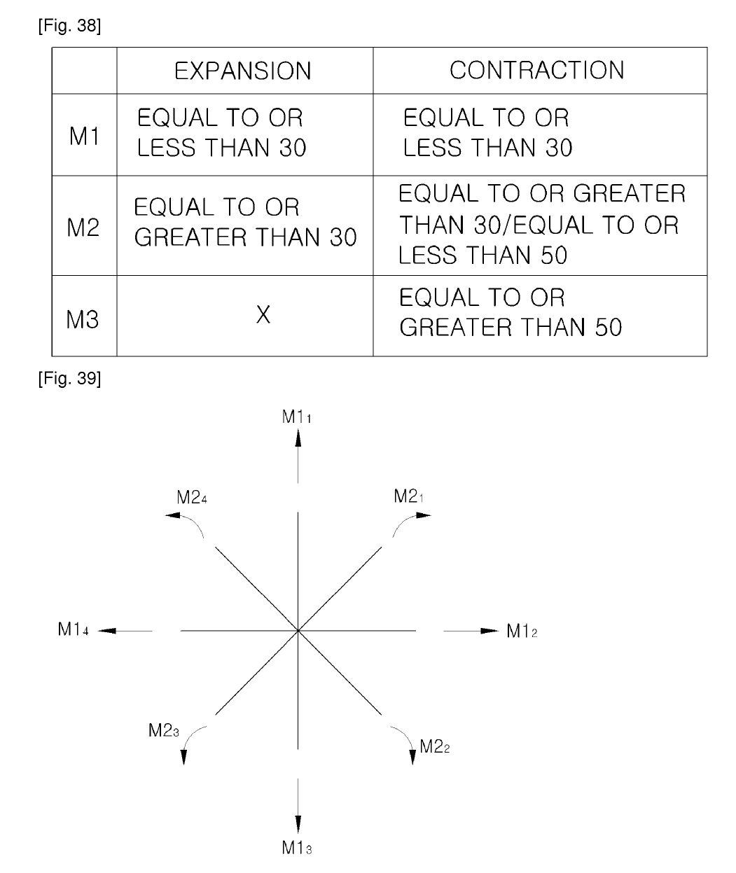

Further, as shown in FIG. 38, a data input device according to the present invention may discriminatively perform respective directional inputs depending on the intensity or direction of pressures applied to the input unit 10 even if the input unit 10 itself is not moved or deformed (a so-called immovable type).

For example, when expansion in any one direction or contraction in another direction is intended to be guided using horizontal pressing pressure, this action may be detected as first directional input M1 when the pressure is equal to or greater than a predetermined value.

Further, when pressing pressure for guiding tilting in a certain direction is equal to or greater than a predetermined value or falls within a predetermined range, this action may be processed as second directional input M2. When pressing pressure applied to a predetermined location is equal to or greater than a predetermined value, this action may be processed as third directional input M3.

For example, on the assumption that respective input values are set, as shown in FIG. 38, when first directional input (M1, pressure=25), second directional input (M2, pressure=40) or third directional input (M3, pressure=50) is performed, it may be determined that first directional input M1 and third directional input M3 have been performed if a total detected pressure value is 75 (because a pressure value of more than 50 is not detected by each of the first directional input M1 and the second directional input M2), and it may be determined that second directional input M2 and third directional input M3 have been performed if a total pressure value is 90.

FIG. 39 illustrates an example in which first direction indication locations m1 and second direction indication locations m2 are alternately arranged.

Referring to the drawing, the first direction indication locations m1 are arranged in four directions, that is, the east, west, south and north directions, and the second direction indication locations m2 are arranged in four directions, that is, the northeast, northwest, southeast, and southwest directions, in alternation with the first direction indication locations.

When it is difficult to tilt the input unit 10 in one direction while moving the input unit 10 in that direction (or another direction) to perform first directional input M1, there is an advantage of more easily performing second directional input M2 if the input unit 10 is tilted downwards while the tilting direction is being slightly turned.

Meanwhile, a transmission/reception unit may be further provided between the data input device of the present invention and various types of terminals, so that the function of a wired or wireless remote control (remote control device) for various types of devices such as portable terminals, desktop computers or digital TVs may be performed.

In this case, the devices may be used as control devices for controlling the input of data such as characters, numbers and symbols required for text input or controlling three-dimensional content through the data input device.

For example, referring to FIG. 41(a), a window enlargement function may be performed through first directional input M1 in the direction of 12 o'clock, and a window reduction function may be performed through first directional input M1 in the direction of 6 o'clock. A quick wind or rewind function may be performed through first directional input M1 in the direction of 3 and 9 o'clock.

That is, the input unit 10 is moved in each direction and used as a mouse, and is tilted downwards or pressed in each direction to use various functions such as play, pause, play next, and screen enlargement/reduction functions.

Further, content may be selected by moving the input unit 10, and functions such as volume control and quick wind functions may be performed by pressing the input unit 10 in each direction on selected content.

Further, a volume or channel control function or the function of jump to a next file may be performed through third directional input.

Further, as shown in FIG. 41(b), a content select function may be performed through first directional input M1 in the direction of 3 or 9 o'clock. Central input C may be added and implemented such that, when a central input portion is weakly pressed, a play function is performed, whereas when the central input portion is pressed strongly, a pause function or the like is performed.

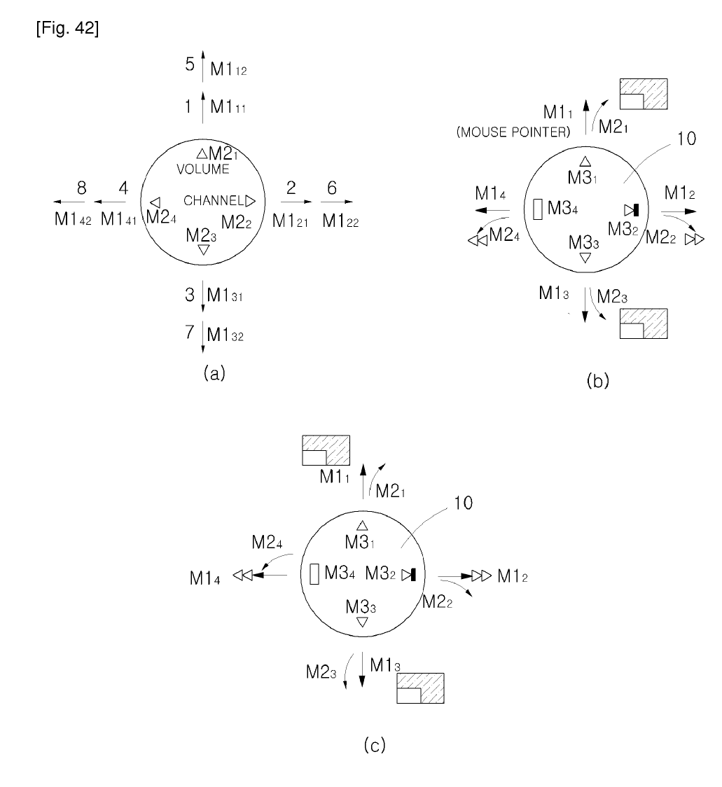

Further, as shown in FIG. 42 (a), when the data input device is used as a TV remote control, it is possible to implement first directional input M1 in two steps, so that numbers ‘1, 2, 3, 4’ may be input through first-step first directional input M1 and numbers ‘5, 6, 7, 8 ’ may be input through second-step first directional input M1.

FIG. 42 (b) illustrates an example in which second directional input M2 is also utilized.

In this case, the functions of FIGS. 41 and 42 show some examples of detailed utilization of the data input device according to the present invention. It should be noted that the combination of respective directional inputs, the number of direction indication locations, and determination of whether to combine central input C and whether to input in multiple steps may be freely adjusted and used.

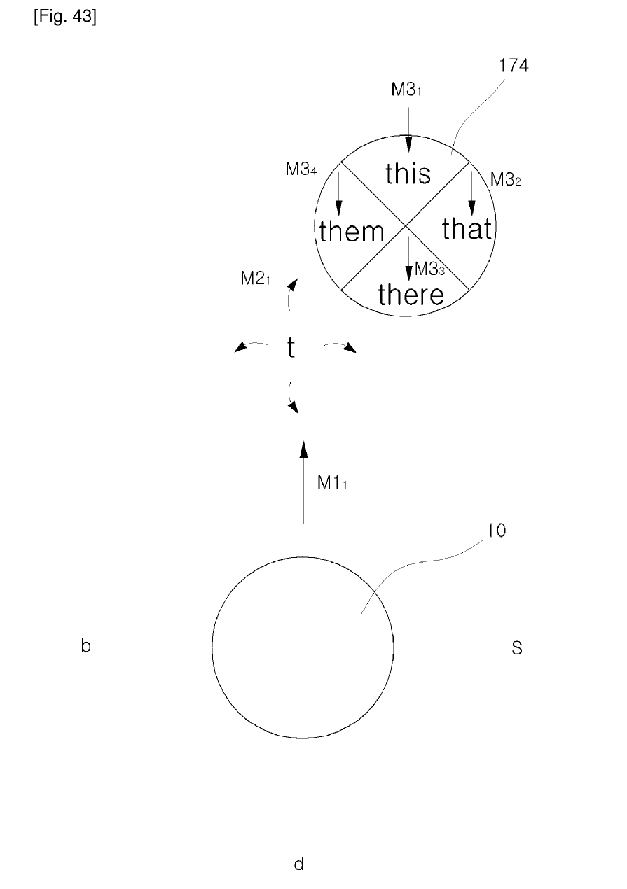

FIG. 43 illustrates a method of inputting derivatives using a data input device according to the present invention.

For example, when first directional input M1 is performed in the direction of 12 o'clock in which the letter ‘t’ is assigned, various derivatives starting from the letter ‘t’ that is, ‘this, that, there, them’ are indicated on a character plate 174.

Here, the character plate 174 for derivatives, indicated after the first directional input M1 has been performed, may be configured differently for respective second direction indication locations m2.

Therefore, when third directional input M3 is performed in a predetermined direction, related derivatives are immediately input, so that there is no need to input the letters except for the first letter, thus obtaining an effect of reducing input time.

In this case, the character plate 174 corresponding to derivatives may be differently displayed whenever each directional input is performed. For example, when first directional input M1 is performed, a character plate 174 on which letters ‘t, s, b, d’ are indicated at respective first direction indication locations m1 is displayed. After the input unit has been moved to the letter ‘t’, a character plate 174 on which relevant derivatives are indicated at respective second direction indication locations m2 is displayed. When second directional input M2 is finally performed in the direction of 12 o'clock, a character plate 174 on which derivatives are indicated as shown in FIG. 43 is displayed.

Derivatives indicated on respective character plates 174 may be classified into categories. For example, derivatives may be classified into, for example, noun, verb, adjective, etc. and may be indicated.

Furthermore, it is apparent that various numbers, functions and characters related to a character or data currently being input may be indicated in addition to the derivatives.

FIG. 44 illustrates detailed examples of derivates or anticipated words attributable to the input of characters.

That is, when first directional input M1 is performed in the direction of 12 o'clock to select the letter ‘S’, a character plate 174 is displayed in such a way that anticipated words assigned to respective second direction indication locations m2 are grouped according to categories or similarity, as shown in FIG. 44.

Further, finally, third directional input M3 is performed to input a desired anticipated word.

In the case where the number of direction indication locations is four, the number of anticipated words that can be input when the input unit is moved to any one first direction indication location m1 is 16 because four third directional input actions M3 are possible for each of the four second direction indication locations m2. Therefore, a total of 64 anticipated words may be input.

Therefore, when the number of direction indication locations for each directional input is five, 5×5×5=125 anticipated words may be input. When the number of direction indication locations of each directional input is six, 6³=216 anticipated words may be input.

That is, when the numbers of direction indication locations for three directional inputs are equally set to ‘a’, the total number of anticipated words that can be input using one input unit 10 is a³, and a total of 2a³ anticipated words may be input if two input units 10 are provided.

Of course, when the numbers of direction indication locations for respective directional inputs are differently set, the number of anticipated words that can be input may be more variable.

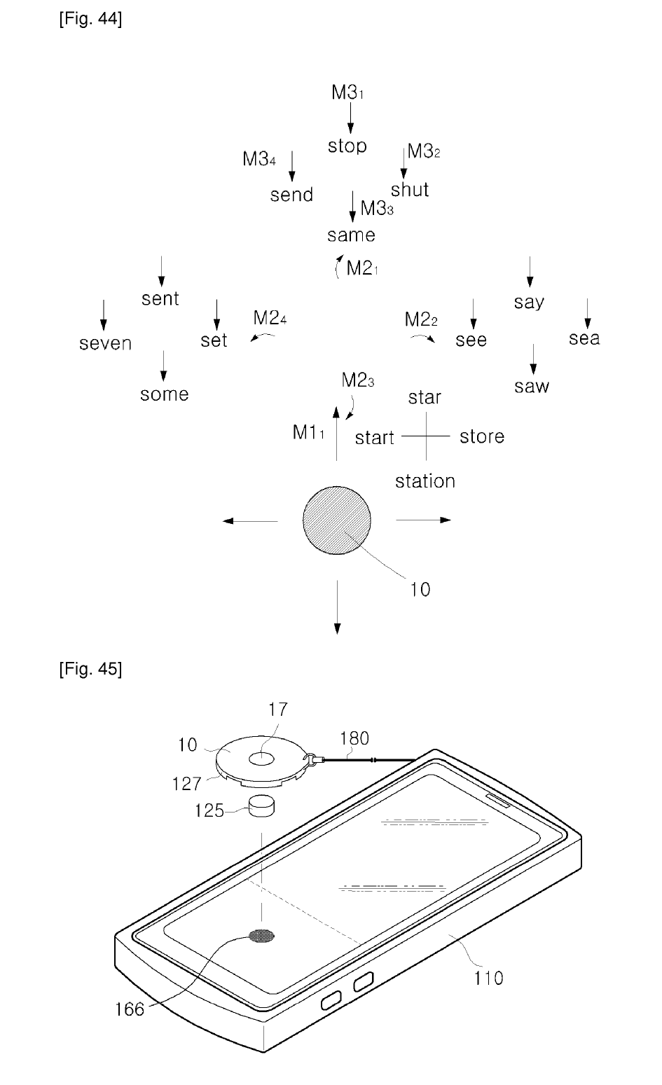

Meanwhile, as shown in FIGS. 45 to 47, an input unit 10 may be detachably or movably provided from the base 110, thus allowing the user to freely change input locations.

For example, as shown in FIG. 45, when the data input device of the present invention is mounted on a portable mobile communication terminal, the input unit 10 is connected to the terminal through a connection element 180, such as a cord made of various materials, so that the input unit 10 may be used, with the input unit 10 put on a touch screen 130 or the like only at the time of inputting data.

In this case, a reference location detection unit 166 is provided on the touch screen 130, so that, when contact with the input unit 10 or a support unit 125 is detected, the mode may be automatically switched to input mode.

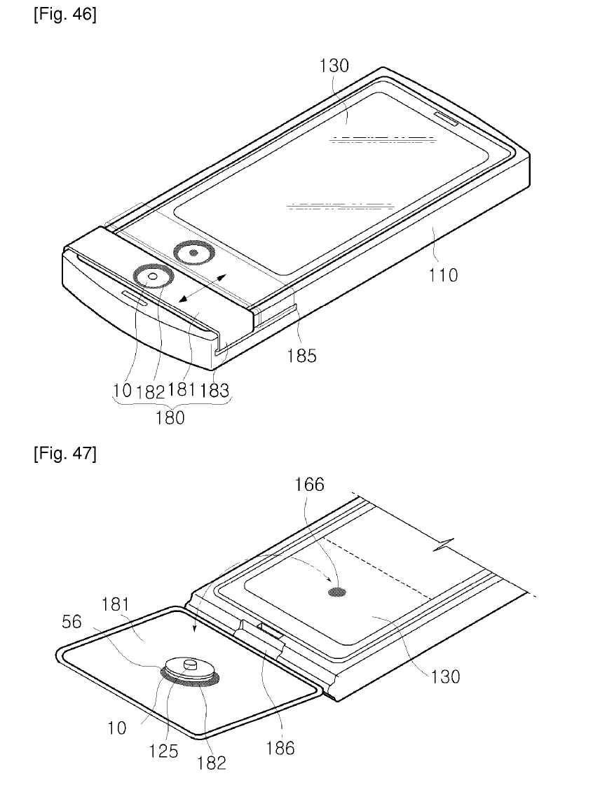

Further, as shown in FIG. 46, the data input device may be configured to provide a connection element 180 including a band-shaped main body 181, a reception part 182 provided in the main body 181 and configured to receive the input unit 10 to enable first directional input M1 and second directional input M2 to be performed, and movable support parts 183 provided at both ends of the main body 181 and slidably coupled to slide grooves 185 formed in the base 110.

In this case, the input unit 10 is moved to an input location while the connection element 180 is moved along the base 110.

Further, as shown in FIG. 47, the input unit 10 is received in a flip-type main body 181, thus being moved to an input location while being rotated by a hinge part 186.

In the respective cases, first detection units 31, second detection units 32 and third detection units 33 for detecting the movement of the input unit 10 may be provided on the touch screen 130.

In this case, as shown in FIG. 30, the locations of the second detection units 63 may be changed according to the movement of the input unit 10, so that, in the state in which first directional input M is performed, the input unit 10 does not need to return to a reference location S and may perform second directional input P at that location.

Meanwhile, as shown in FIG. 43, on the touch screen 130, a character plate 174 on which characters input through first directional input M1, second directional input M2 and third directional input M3 are displayed may be provided. In this case, the character plate 174 may be moved along with the input unit 10 when the input unit 10 is moved.

It is apparent that the data input device of the present invention is not limited by the implementation form and purpose thereof, and those skilled in the art can easily modify and implement the present invention in various forms, so that any data input device, capable of performing input according to the spirit of the present invention regardless of the implementation form and purpose, belongs to the scope of the present invention.

1. A data input device, comprising:
a base;
an input unit provided on the base, wherein the input unit is provided to enable first directional input in which the input unit is laterally moved from a reference location to any one of a plurality of first direction indication locations arranged radially around the reference location and spaced apart from one another within a predetermined input radius, second directional input in which the entire input unit is tilted downwards and moved from a horizontal position to a direction of any one of a plurality of second direction indication locations arranged radially around the reference location and spaced apart from one another, and third directional input in which any one of a plurality of third direction indication locations arranged radially on the input unit itself and spaced apart from one another is selected, to be independently performed;
first detection units for detecting lateral movement of the input unit;
second detection units for detecting tilting movement of the input unit;
third detection units for detecting the third directional input; and
a control unit for extracting a first character assigned to each first direction indication location, a second character assigned to each second direction indication location, and a third character assigned to each third direction indication location from a memory unit and inputting the extracted characters on a basis of results of detection of the first, second and third detection units.

2. The data input device according to claim 1, wherein the third directional input is performed in such a way that the input unit is tilted downwards to a direction of any one of the third direction indication locations, or any one of press parts provided on the input unit to correspond to the respective third direction indication locations is selected.

3. (canceled)

4. The data input device according to claim 1, wherein the input unit is configured to enable central input to be performed using one or more of a method in which a central input key provided at a center of the input unit is selected and a method in which the entire input unit is moved vertically to the base.

5. The data input device according to claim 4, wherein the central input is provided to be performed in two or more steps, that is, in multiple steps.

6. The data input device according to claim 4, wherein when combined central input performed through combination with any one of the central input, the first directional input, the second directional input and the third directional input is performed, characters different from characters originally assigned to the first direction indication locations, the second direction indication locations and the third direction indication locations are input.

7. The data input device according to claim 1, wherein one or more of the first directional input, the second directional input and the third directional input are provided to be performed in two or more steps, that is, in multiple steps, depending on distance of lateral movement of the input unit, a degree of tilting movement, an angle of tilting, a distance of pressing of the press parts, or intensity of pressing pressure.

8-9. (canceled)

10. The data input device according to claim 1, further comprising a first elastic part provided between a bottom of the input unit and the base and configured to support the input unit so that the input unit is laterally moved along a top surface of the first elastic part, and to return the input unit to an initial position at a time of performing tilting movement of the input unit, and a second elastic part provided between a circumferential portion of the input unit and the base and configured to return the input unit to the initial position at a time of performing lateral movement of the input unit.

11-12. (canceled)

13. The data input device according to claim 1, further comprising a hemispheric support unit provided between the bottom of the input unit and the base and curved toward the input unit; and wherein the input unit comprises a first input unit, a bottom contact surface of which corresponds to a top surface of the support unit and which is tilted downwards and moved along the support unit, and a second input unit placed on a top surface of the first input unit and provided to be laterally movable along the top surface of the first input unit.

14-15. (canceled)

16. The data input device according to claim 13, further comprising an input switching unit disposed between the first input unit and the second input unit and configured to enable tilting movement of the first input unit or lateral movement of the second input unit to be selectively performed.

17. The data input device according to claim 1, further comprising a movable support unit provided between the bottom of the input unit and the base and configured to have a hemispheric shape, curved toward the input unit and to be laterally moved together with the input unit at a time of performing the first directional input, third protrusions protruding toward the third detection units arranged on the base, and a central protrusion protruding toward the central input detection unit, the third protrusions and the central protrusion being formed on a bottom of the movable support unit; and wherein the input unit has a bottom contact surface corresponding to a shape of a top surface of the movable support unit, and performs the second directional input in such a way that the input unit is tilted downwards and moved along with the movable support unit.

18-26. (canceled)

27. The data input device according to claim 1, wherein the first, second and third detection units are implemented using a touch pad or a touch screen arranged in an input area.

28. The data input device according to claim 27, further comprising a connection element for enabling the input unit to be put on the base provided in the input area, thus enabling the respective directional inputs to be performed.

29-31. (canceled)

32. The data input device according to claim 1, wherein combined directional input, in which two or more of the first directional input, the second directional input and the third directional input are combined with each other to generate new input signals, is provided to be performed.

33. The data input device according to claim 32, wherein the combined directional input is configured to generate different input signals according to a sequence of combination of the respective directional inputs.

34. The data input device according to claim 4, wherein new input signals are generated through combined central input in which, after any one of the first directional input, the second directional input and the third directional input is primarily performed, the central input is performed, and then any one of the respective directional inputs is subsequently performed.

35. The data input device according to claim 1, wherein: a display unit provided on the base comprises a character display unit on which characters to be input through the respective directional inputs or the central input are indicated; and the character display unit is configured such that, when the directional inputs or the central input are sequentially performed, characters that can be input at respective input locations or anticipated words thereof are indicated, thus enabling a relevant character or a relevant anticipated word thereof to be input at a time when a relevant input action is performed.

36-53. (canceled)

54. A data input device, comprising:
a base;
an input unit provided on the base, wherein the input unit is provided to enable first directional input in which the input unit is laterally moved from a reference location to each first direction indication location, second directional input in which a press location provided at each of second direction indication locations arranged along a peripheral portion of the input unit is selected, and third directional input in which a press location provided at each of third direction indication locations arranged along the peripheral portion of the input unit in alternation with the second direction indication locations is selected, to be independently performed;
a first detection unit for detecting the first directional input;
a second detection unit for detecting the second directional input;
a third detection unit for detecting the third directional input; and
a control unit for extracting a first character assigned to each first direction indication location, a second character assigned to each second direction indication location, and a third character assigned to each third direction indication location from a memory unit and inputting the extracted characters on a basis of results of detection of the first, second and third detection units.

55. The data input device according to claim 54, wherein the input unit comprises an inward input unit in which respective press locations protrude to correspond to the second direction indication locations, and a plurality of outward input units provided to correspond to the respective third direction indication locations.

56-60. (canceled)

61. The data input device according to claim 1, wherein the input unit comprises:
an inward input unit for performing the third directional input in which any one of the plurality of third direction indication locations arranged radially around the reference location and spaced apart from one another is selected from the horizontal position, and
an outward input unit provided along a peripheral portion of the inward input unit outside the inward input unit and configured to perform the second directional input in which the outward input unit is tilted downwards to a direction of any one of the plurality of second direction indication locations arranged radially around the reference location and spaced apart from one another,
wherein the inward and outward input units are simultaneously laterally moved from the reference location to any one of the plurality of first direction indication locations arranged radially around the reference location and spaced apart from one another, to be performed.

62. The data input device according to claim 1, wherein the input unit comprises:
an inward input unit for performing the second directional input in which the inward input unit is tilted from the horizontal position downwards to a direction of any one of the plurality of second direction indication locations arranged radially around the reference location and spaced apart from one another, and
an outward input unit provided along a peripheral portion of the inward input unit outside the inward input unit and configured to perform the third directional input in which any one of the plurality of third direction indication locations arranged radially around the reference location and spaced apart from one another is selected,
wherein the inward and the outward input units are simultaneously laterally moved from the reference location to any one of the plurality of first direction indication locations arranged radially around the reference location and spaced apart from one another, to be performed.

63. The data input device according to claim 1, further comprising a movable support unit provided on the base, and
wherein the input unit is placed on the movable support unit, and performs the first directional input in such a way that both the input unit and the movable support unit are laterally moved from the reference location to each radial direction, the second directional input in such a way that the input unit is tilted downwards in each radial direction on a top of the movable support unit, and the third directional input in such a way that a peripheral portion of the top of the input unit corresponding to each radial direction is pressed.

64. The data input device according to claim 1, further comprising a movable support unit provided on the base, and
wherein the input unit is placed on the movable support unit, and performs the first directional input in such a way that both the input unit and the movable support unit are laterally moved from the reference location to each radial direction, the second directional input in such a way that a peripheral portion of a top of the input unit corresponding to each radial direction is tilted downwards, and the third directional input in such a way that the peripheral portion of the top of the input unit corresponding to each radial direction is pressed.

65. The data input device according to claim 1, wherein the input unit is provided on the base in a disk shape and provided with a rod-shaped support projection which is formed on a bottom of the input unit and protrudes toward the base, and
further comprising a support unit provided between the base and the input unit and provided with a reception hole which is formed at a center of the support unit to receive the support projection to enable tilting.

66. The data input device according to claim 1, wherein the third directional input is performed in such a way that the input unit is tilted downwards to a direction of each of the third direction indication locations arranged in alternation with the second direction indication locations.

67. The data input device according to claim 1, wherein the input unit comprises:
a first input unit provided on the base and configured to perform the first directional input in which the first input unit is laterally moved from the reference location to each of the first direction indication locations, and
a second input unit formed in a shape of a star having projections extending radially from a center thereof, and provided on the first input unit, the second input unit being provided to enable the second directional input in which the second input unit is tilted downwards to a direction of each of the second direction indication locations corresponding to the respective projections and the third directional input in which the second input unit is pressed at each of the third direction indication locations corresponding to the projections.
